(19) United States
(12) Patent Application Publication
(10) Pub. No.: US 2007/0165979 A1
(43) Pub. Date: Jul. 19, 2007

(54) Optical input substrate, optical output substrate, optical input/output substrate, a fabrication method for these substrates, and an optical element integrated semiconductor integrated circuit

(76) Inventors: Mikio Oda, Tokyo (JP); Hisaya Takahashi, Tokyo (JP); Kaichiro Nakano, Tokyo (JP); Hikaru Kouta, Tokyo (JP); Kohroh Kobayashi, Tokyo (JP)

Correspondence Address: SCULLY SCOTT MURPHY & PRESSER, PC, 400 GARDEN CITY PLAZA, SUITE 300, GARDEN CITY, NY, 11530, US

(21) Appl. No.: 10/584,736

(22) PCT Filed: Oct. 14, 2004
(86) PCT No.: PCT/JP04/15159

§ 371 Date: Jun. 26, 2006

(30) Foreign Application Priority Data
Dec. 26, 2003 (JP) 2003-434028

(51) Int. Cl. G02B 6/12

(52) U.S. Cl. 385/14

(57) ABSTRACT

Photodetectors 2a capable of converting optical signals that are received as input from the outside to electrical signals and supplying these electrical signals as output to output ports are mounted on two or more input ports of substrate 1 on which a semiconductor integrated circuit can be mounted; and moreover, the heights of these two or more photodetectors 2a are uniformly aligned, and the electrical signal input ports of the semiconductor integrated circuit that is mounted can be connected to the output ports of the above-described substrate 1.

### TECHNICAL FIELD

The present invention relates to a semiconductor integrated circuit (hereinbelow referred to as an “LSI”)

### BACKGROUND ART

Although the processing speed of LSI is progressing toward ever-higher levels, there is a limit to the transmission capabilities of electrical wiring between a plurality of LSI, and attention has therefore focused on transmission that employs optical signals, optical signals being not only capable of high-speed transmission and long-distance transmission but also featuring less radiation of electromagnetic noise. It is believed that if an electrical signal that is supplied as output from a particular LSI is converted to an optical signal for transmission by an optical line and then reconverted to an electrical signal before input to another LSI, a higher transmission speed can be realized than when using an electrical signal alone.

JP-A-2001-036197 discloses an optoelectronic-integrated element in which optical elements and an LSI connected by electrical wiring are integrated within the same package. In this optoelectronic integrated element, an electronic integrated element bare chip is secured on a base plate, and optical elements are secured in proximity to this bare chip with an interconnect means interposed. In this case, the optical elements are a surface-emission laser array or a photodetector array and are directly mounted on inner leads or on the electronic integrated element. The input/output ports of the electronic integrated element are each arranged around the periphery of the electronic integrated element with the photodetector array mounted to correspond to the input ports and the surface emission lasers mounted to correspond to the output ports. More specifically, in a form in which the optical elements are directly mounted on the electronic integrated element, the pads of the optical elements are electrically connected to the input/output ports of the electronic integrated element that are arranged to correspond with the arrangement of these pads. Alternatively, in the form in which the electronic integrated element and optical element are electrically connected by inner leads, the pads on which the electronic integrated element is mounted and the pads on which the optical element array is mounted (which are arranged to match the pad arrangement of the optical element array in order to mount the optical element array) are electrically connected through the use of inner leads that have a one-to-one correspondence with the pads.

However, the prior art described in the aforementioned patent document 1 is technology that presupposes that the input/output ports of the electrical wiring substrate such as inner leads are arranged in one location, and further, that the input/output ports are aligned regularly in fixed directions. Accordingly, when there is a plurality of input/output ports of the electrical wiring substrate, and moreover, when these input/output ports are randomly (irregularly) arranged, the photodetector and light-emitting device of one channel must be prepared in exactly the number required, and these elements must be mounted one at a time to match the positions of the input/output ports of the electrical wiring substrate. However, mounting a plurality of optical elements one at a time results in disparity in the heights of the photoreceptor surfaces and light-emitting surfaces of each optical element and an increase in loss of the optical coupling with external devices. In addition, the mounting of optical elements becomes time-consuming and prone to high costs.

### DISCLOSURE OF THE INVENTION

It is an object of the present invention to provide an electrical wiring substrate in which the heights of photodetectors that are mounted at two or more randomly arranged input ports are uniform.

It is another object of the present invention to provide an electrical wiring substrate in which the heights of light-emitting devices that are mounted at two or more randomly arranged output ports are uniform.

It is another object of the present invention to provide an electrical wiring substrate in which the heights of photodetectors and light-emitting devices that are mounted at two or more randomly arranged input ports and output ports are uniform.

It is another object of the present invention to provide an electrical wiring substrate in which the heights of photodetectors and light-emitting devices that are provided at two or more randomly arranged input ports and output ports are all uniform.

It is another object of the present invention to provide a method for fabricating the above-described electrical wiring substrate by the fewest possible fabrication steps and at low cost.

It is another object of the present invention to provide an optical element-integrated semiconductor integrated circuit in which semiconductor integrated circuits are mounted on the above-described electrical wiring substrate.

One form of the present invention for achieving at least one of the above-described objects is a substrate on which an LSI can be mounted, on which two or more optical elements are mounted, and in which the heights of these two or more optical elements are uniform. In this case, the above-described optical elements can be photodetectors that are capable of converting optical signals received as input to electrical signals and supplying these electrical signals as output to an LSI that is mounted on the substrate. Alternatively, the above-described optical elements can be light-emitting devices capable of converting electrical signals that are supplied as output from a mounted LSI to optical signals and supplying these optical signals to the outside. Alternatively, these optical elements can be both the above-described photodetectors and light-emitting devices.

In this case, when the above-described optical element is a photodetector, the “height of an optical element” indicates the distance from the surface of the substrate on which the photodetector is mounted (mounting surface) to the photoreception surface of the photodetector. On the other hand, when the optical element is a light-emitting device, the “height of the optical element” indicates the distance from the surface of the substrate on which the light-emitting device is mounted (the mounting surface) to the light-emitting surface of the light-emitting device.

The electrode pattern can be common to the two or more optical elements that are mounted on the above-described substrate. As an example, when two or more photodetectors are mounted, all or a portion of these photodetectors can share the electrode pattern. When two or more light-emitting devices are mounted, all or a portion of these light-emitting devices can share the electrode pattern. Finally, when both photodetectors and light-emitting devices are mounted, the electrode pattern can be common to the photodetectors and light-emitting devices.

In addition, an optics element having the effect of focusing incident light can be provided in at least one of the two or more optical elements that are mounted on the above-described substrate. For example, when the optical element is a photodetector, a lens may be provided that has the action of focusing light that is received as input from the outside toward the photoreception surface of the photodetector. When the optical element is a light-emitting device, a lens can be provided that has the action of focusing light that is to be supplied from the light-emitting surface of the light-emitting device to the outside toward the incident surface of the light.

Another form of the present invention is an optical element integrated semiconductor integrated circuit capable of receiving optical signal input, in which an LSI is mounted on the above-described optical input substrate of the present invention, and in which optical signals received as input from the outside are converted to electrical signals by the photodetectors of the optical input substrate and then supplied as output to electrical signal input ports of the LSI. In this case, when the electrical signal input ports of the LSI are irregularly arranged, these electrical signal input ports can be rearranged by wiring to input ports (on which photodetectors are mounted) of the optical input substrate that are arranged regularly.

Another form of the present invention is a optical-element integrated semiconductor integrated circuit capable of output of an optical signal in which an LSI is mounted on an optical output substrate of the above-described present invention, and in which electrical signals that are supplied from the mounted LSI are converted to optical signals by light-emitting devices of the optical output substrate and then supplied as output to the outside. In this case, when the electrical signal output ports of the LSI are arranged irregularly, these electrical signal output ports can be rearranged by connecting the electrical signal output ports to the output ports (light-emitting devices are mounted) of the optical output substrate that are arranged regularly. Another form of the present invention is an optical element-integrated semiconductor integrated circuit capable of output and input of optical signals in which an LSI is mounted on the above-described optical input/output substrate of the present invention, and in which optical signals that are received as input from the outside are converted to electrical signals by photodetectors of the optical input/output substrate and then supplied as output to electrical signal input ports of the LSI, and electrical signals that are supplied from the LSI are converted to optical signals by the light-emitting devices of the optical input/output substrate and then supplied to the outside. In this case as well, both or either of electrical signal input ports and electrical signal output ports of the semiconductor integrated circuit that are irregularly arranged can be rearranged by the same method as described above. Another form of the present invention is a method for fabricating the optical input substrate, the optical output substrate, or the optical input/output substrate of the present invention in which optical elements are mounted on a substrate by either or both of: an optical element mounting step in which, by mounting on the substrate an optical element array from which unnecessary optical elements have been removed in advance, two or more optical elements are mounted as a group on the substrate; and an optical element mounting step in which, by mounting an optical element array on the substrate and then removing unnecessary optical elements, two or more optical elements are mounted as a group on the substrate. In this case as well, the above-described optical elements can be photodetectors, light-emitting devices, or a combination of these two types of elements. When the above-described optical elements are photodetectors, the above-described “optical element array” clearly indicates a photodetector array in which a plurality of photodetectors are formed on the element substrate. Alternatively, when the optical elements are light-emitting devices, the above-described “optical element array” obviously indicates a light-emitting device array in which a plurality of light-emitting devices are formed on an element substrate.

The method of fabricating the optical input substrate, optical output substrate, and optical input/output substrate of the present invention can include a step of etching the element substrate of the above-described optical element array to produce a thin film, or a step of etching the element substrate to produce a lens.

In an optical input substrate, an optical output substrate, or an optical input/output substrate of the present invention having the above-described characteristics, the heights of one or both of two or more photodetectors and light-emitting devices that have been mounted are aligned uniformly.

Accordingly, if an LSI is mounted on this substrate to fabricate an optical element-integrated semiconductor integrated circuit, an optical element-integrated semiconductor integrated circuit can be provided that is equipped with one or both of light-emitting devices and photodetectors having uniform heights. Such an optical element-integrated semiconductor integrated circuit is capable of realizing transmission at high speed, over long distances, and moreover, with superior resistance to noise due to optical coupling with a plurality of optical circuits such as optical fiber and optical waveguides. In addition, the alignment of the heights of the coupling parts of optical circuits that are to be optically coupled with photodetectors/light-emitting devices in the above-described environment of use obtains the effect of realizing highly efficient optical coupling for all channels of the photodetector/light-emitting devices. Still further, the realization of highly efficient optical coupling on all channels enables effective use of the optical signal strength and thus obtains the effect of enabling transmission over even greater distances. Alternatively, in optical transmission over short distances, the highly efficient optical coupling enables transmission of optical signals at high strength to obtain the effect of improving resistance to noise.

In addition, the fabrication of an optical input substrate, an optical output substrate, or an optical input/output substrate by means of the fabrication method of the present invention having the above-described characteristics enables reliable and easy alignment of the heights of two or more optical elements. Further, the number of fabrication steps is reduced from a case in which a plurality of optical elements are successively and individually mounted one by one, whereby a reduction of costs can be anticipated. This effect becomes more conspicuous as the number of mounted optical elements increases.

### BRIEF DESCRIPTION OF THE DRAWINGS

FIG. 1A is a schematic plan view showing an example of an optical output substrate of the present invention;

FIG. 1B is a schematic sectional view showing an example of an optical output substrate of the present invention;

FIG. 1C is a schematic sectional view showing an optical element-integrated LSI that uses the optical output substrate shown in FIGS. 1A and 1B;

FIG. 2A is a schematic view showing one fabrication step of the optical-element integrated LSI shown in FIGS. 1A and 1B;

FIG. 2B is a schematic view showing the step that follows the fabrication step shown in FIG. 2A;

FIG. 2C is a schematic view showing the step that follows the fabrication step shown in FIG. 2B;

FIG. 2D is a schematic view showing the step that follows the fabrication step shown in FIG. 2C;

FIG. 3A is a schematic plan view showing an example of the optical input substrate of the present invention;

FIG. 3B is a schematic sectional view showing an example of the optical input substrate of the present invention;

FIG. 3C is a schematic sectional view showing an optical-element integrated LSI that uses the optical input substrate shown in FIG. 3A and FIG. 3B;

FIG. 4A is a schematic view showing one fabrication step of the optical input substrate shown in FIGS. 3A and 3B;

FIG. 4B is a schematic view showing the step that follows the fabrication step shown in FIG. 4A;

FIG. 4C is a schematic view showing the step that follows the fabrication step shown in FIG. 4B;

FIG. 4D is a schematic view showing the step that follows the fabrication step shown in FIG. 4C;

FIG. 4E is a schematic view showing the step that follows the fabrication step shown in FIG. 4D;

FIG. 5A is a schematic plan view showing an example of the optical input/output substrate of the present invention;

FIG. 5B is a schematic sectional view showing an example of the optical input/output substrate of the present invention;

FIG. 5C is a schematic sectional view showing an optical-element integrated LSI that uses the optical input/output substrate shown in FIG. 5A and FIG. 5B;

FIG. 5D is a schematic sectional view showing a modification of the optical-element integrated LSI;

FIG. 6A is a schematic view showing one fabrication step of the optical input/output substrate shown in FIG. 5A and FIG. 5B;

FIG. 6B is a schematic view showing the step that follows the fabrication step shown in FIG. 6A;

FIG. 6C is a schematic view showing the step that follows the fabrication step shown in FIG. 6B;

FIG. 6D is a schematic view showing the step that follows the fabrication step shown in FIG. 6C;

FIG. 6E is a schematic view showing the step that follows the fabrication step shown in FIG. 6D;

FIG. 6F is a schematic view showing the step that follows the fabrication step shown in FIG. 6E;

FIG. 6G is a schematic view showing the step that follows the fabrication step shown in FIG. 6F;

FIG. 6H is a schematic view showing the step that follows the fabrication step shown in FIG. 6G;

FIG. 6I is a schematic view showing the step that follows the fabrication step shown in FIG. 6H;

FIG. 7A is a schematic view showing a step of another fabrication method of the optical input/output substrate shown in FIG. 5A and FIG. 5B;

FIG. 7B is a schematic view showing the step that follows the fabrication step shown in FIG. 7A;

FIG. 7C is a schematic view showing the step that follows the fabrication step shown in FIG. 7B;

FIG. 7D is a schematic view showing the step that follows the fabrication step shown in FIG. 7C;

FIG. 7E is a schematic view showing the step that follows the fabrication step shown in FIG. 7D;

FIG. 7F is a schematic view showing the step that follows the fabrication step shown in FIG. 7E;

FIG. 7G is a schematic view showing the step that follows the fabrication step shown in FIG. 7F;

FIG. 7H is a schematic view showing the step that follows the fabrication step shown in FIG. 7G;

FIG. 7I is a schematic view showing: the step that follows the fabrication step shown in FIG. 7H;

FIG. 8A is a schematic view showing a fabrication step that substitutes for the fabrication step shown in FIG. 6G;

FIG. 8B is a schematic view showing a fabrication step that substitutes for the fabrication step shown in FIG. 6H;

FIG. 8C is a schematic view showing a fabrication step that substitutes for the fabrication step shown in FIG. 6I;

FIG. 9 is a schematic plan view showing an example of the relation between the designed mounting positions and the actual mounting positions of an optical element;

FIG. 10A is a schematic plan view showing another example of the optical input/output substrate of the present invention;

FIG. 10B is a schematic plan view showing another example of the optical input/output substrate of the present invention;

FIG. 10C is a schematic enlarged sectional view showing an example of an optical element;

FIG. 10D is a schematic enlarged sectional view showing another example of an optical element;

FIG. 11A is a schematic sectional view showing another example of the optical input/output substrate of the present invention;

FIG. 11B is a schematic sectional view showing another example of the optical input/output substrate of the present invention;

FIG. 12 is a schematic sectional view showing another example of the optical input/output substrate of the present invention;

FIG. 13A is a schematic sectional view showing another example of the optical input/output substrate of the present invention;

FIG. 13B is a schematic sectional view showing a portion of the fabrication steps of the optical input/output substrate of FIG. 13A;

FIG. 13C is a schematic sectional view showing an optical-element integrated LSI that uses the optical input/output substrate of FIG. 13A;

FIG. 14A is a schematic plan view showing another example of the optical input/output substrate of the present invention;

FIG. 14B is a schematic sectional view showing another example of the optical input/output substrate of the present invention;

FIG. 14C is a schematic sectional view showing an optical-element integrated LSI that uses the optical input/output substrate of FIGS. 14A and 14B;

FIG. 15A is a schematic view showing one fabrication step of the optical input/output substrate shown in FIG. 14A and FIG. 14B;

FIG. 15B is a schematic view showing the step that follows the fabrication step shown in FIG. 15A;

FIG. 15C is a schematic view showing the step that follows the fabrication step shown in FIG. 15B;

FIG. 15D is a schematic view showing the step that follows the fabrication step shown in FIG. 15C;

FIG. 15E is a schematic view showing the step that follows the fabrication step shown in FIG. 15D;

FIG. 15F is a schematic view showing the step that follows the fabrication step shown in FIG. 15E;

FIG. 15G is a schematic view showing the step that follows the fabrication step shown in FIG. 15F;

FIG. 15H is a schematic view showing the step that follows the fabrication step shown in FIG. 15G;

FIG. 15I is a schematic view showing the step that follows the fabrication step shown in FIG. 15H;

FIG. 15JJ is a schematic view showing the step that follows the fabrication step shown in FIG. 15I;

FIG. 15K is a schematic view showing the step that follows the fabrication step shown in FIG. 15J;

FIG. 15L is a schematic view showing the step that follows the fabrication step shown in FIG. 15K;

FIG. 16A is a schematic plan view showing another example of an optical input/output substrate;

FIG. 16B is a schematic sectional view showing another example of an optical input/output substrate;

FIG. 17A is a schematic plan view showing an example of an optical input/output substrate fabricated by a fabrication method of the prior art;

FIG. 17B is a schematic sectional view showing an example of an optical input/output substrate fabricated by a fabrication method of the prior art;

FIG. 18A is a schematic plan view showing an example of an optical input/output substrate fabricated by the fabrication method of the present invention;

FIG. 18B is a schematic sectional view showing an example of an optical input/output substrate fabricated by the fabrication method of the present invention;

FIG. 19A is a schematic view showing one fabrication step of the optical-element integrated LSI of the present invention;

FIG. 19B is a schematic view showing the step that follows the fabrication step shown in FIG. 19A;

FIG. 19C is a schematic view showing the step that follows the fabrication step shown in FIG. 19B;

FIG. 20 is a schematic sectional view showing another example of an optical-element integrated LSI of the present invention;

FIG. 21 is a schematic plan view showing another example of an optical input/output substrate of the present invention;

FIG. 22A is a schematic sectional view showing another example of an optical-element integrated LSI of the present invention;

FIG. 22B is a schematic sectional view showing another example an optical-element integrated LSI of the present invention;

FIG. 23A is a schematic sectional view showing another example of an optical-element integrated LSI of the present invention;

FIG. 23B is a schematic sectional view showing another example of an optical-element integrated LSI of the present invention;

FIG. 24A is a schematic sectional view of the state in which an optical-element integrated LSI of the present invention is mounted on an optoelectrical hybrid substrate; and

FIG. 24B is a schematic sectional view of the state in which an optical-element integrated LSI of the prior art is mounted on an optoelectrical hybrid substrate.

### BEST MODE FOR CARRYING OUT THE INVENTION

### First Embodiment

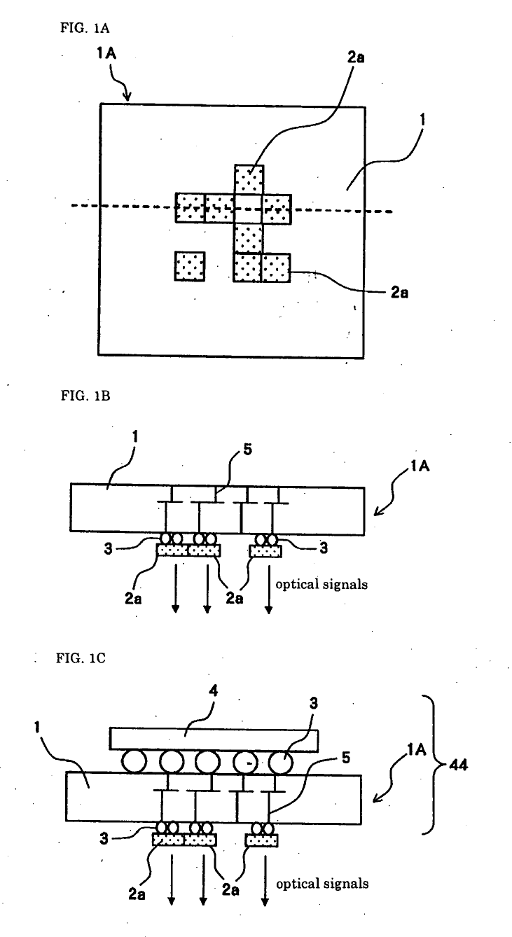

The following explanation regards the details of an example of an optical output substrate and an optical-element integrated semiconductor integrated circuit (hereinbelow referred to as an “optical-element integrated LSI”) based on the accompanying figures. FIG. 1A is a schematic plan view showing the overall structure of optical output substrate 1A of this example, and FIG. 1B is a schematic sectional view showing the overall structure of optical output substrate 1A. FIG. 1C is a schematic sectional view showing the overall structure of optical-element integrated LSI 44 of this example.

In optical output substrate 1A of the present example, light-emitting devices 2a are electrically connected by solder bumps 3 to output ports (not shown) formed on one surface (the rear surface in this example) of substrate 1. A plurality of output ports is present on the rear surface of substrate 1. These output ports are arranged randomly in various positions and a light-emitting device 2a is mounted to correspond to each output port. A device that can deliver light to the rear-surface side of substrate 1 (downward in FIG. 1B) is used for light-emitting device 2a. Accordingly, when an ON/OFF electrical signal is supplied as output from an output port of substrate 1, this electrical signal is applied to light-emitting device 2a, converted to an optical signal, and supplied downward as an ON/OFF optical signal.

In optical-element integrated LSI 44 of this example, LSI 4 is mounted on optical output substrate 1A shown in FIGS. 1A and 1B. In addition, the electrical signal output ports (not shown) of LSI 4 are electrically connected by solder bumps 3 to the input ports (not shown) of substrate 1. As a result, LSI 4 and each light-emitting device 2a are electrically connected by way of electrical wiring 5 of optical output substrate 1A. Accordingly, when ON/OFF electrical signals are supplied as output from the electrical signal output ports of LSI 4, the supplied electrical signals are supplied from the output ports of optical output substrate 1A, applied as input to light-emitting device 2a, and supplied as ON/OFF optical signals.

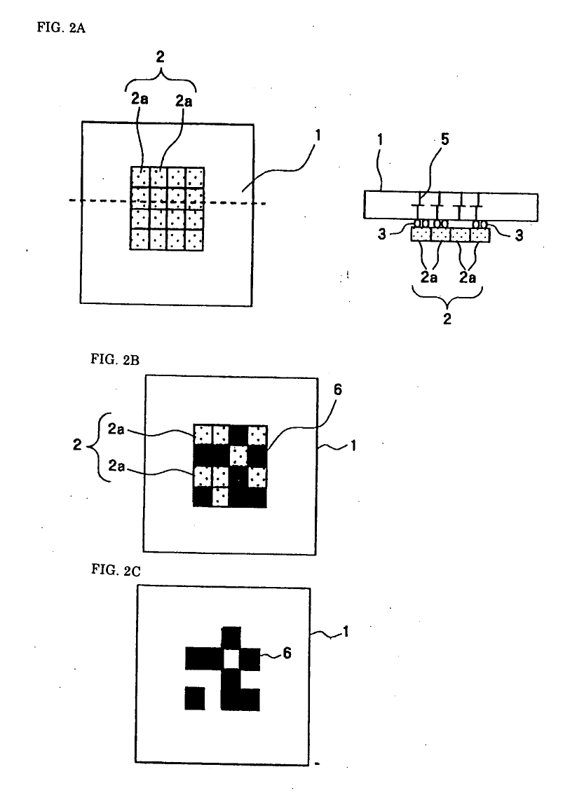

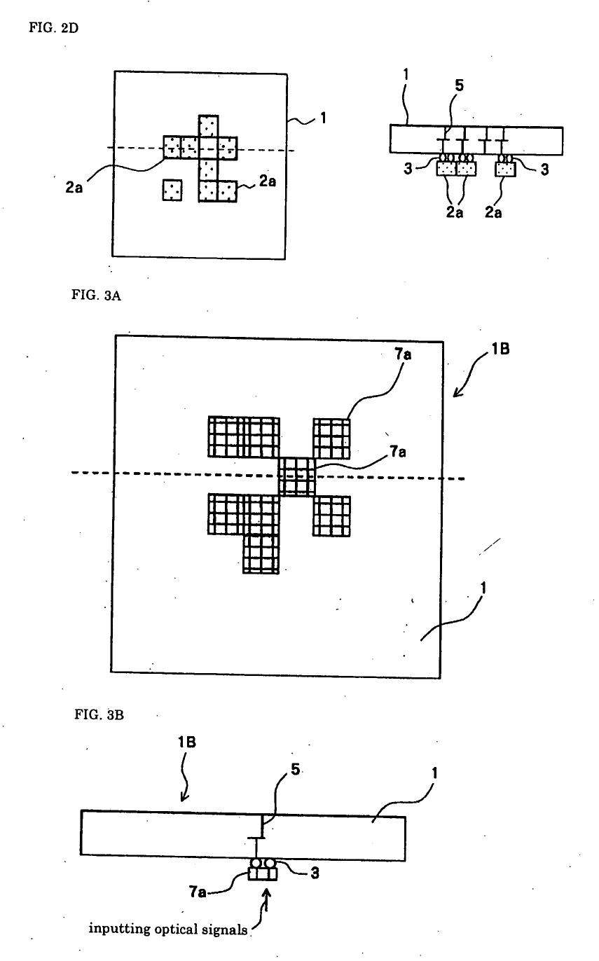

FIGS. 2A-2D show the fabrication method of optical output substrate 1A that is shown in FIGS. 1A and 1B. This explanation of the fabrication method takes as an example substrate 1 having eight output ports, but the number of light-emitting devices can be increased or decreased as appropriate when the number of output ports differs.

As shown in FIG. 2A, a light-emitting device array 2 is prepared in which light-emitting devices 2a are arranged in four rows and four columns on the element substrate. Of the plurality of light-emitting devices 2a that make up light-emitting device array 2, solder bumps 3 are formed on the pads of necessary light-emitting devices 2a, and solder bumps 3 that have been formed are used to electrically connect light-emitting device, array 2 to substrate 1. In this case, “necessary light-emitting devices 2a” indicates light-emitting devices 2a that are to be electrically connected to output ports of substrate 1. Accordingly, light-emitting devices 2a that are not electrically connected to output ports of substrate 1 are placed on substrate 1 but are not electrically connected to substrate 1.

Next, as shown in FIG. 2B, protective film 6 is formed to cover only necessary light-emitting devices 2a among light-emitting device array 2. This example uses protective film 6 that is patterned by exposing and developing a resist. Unnecessary light-emitting devices 2a are next removed by etching as shown in FIG. 2C. Protective film 6 is then removed as shown in FIG. 2D.

By means of the above-described steps, optical output substrate 1A is fabricated in which light-emitting devices 2a are mounted on each of a plurality of output ports arranged at any positions of substrate 1. By further mounting LSI 4 on optical output substrate 1A that has been fabricated and electrically connecting the electrical signal output ports of LSI 4 to the input ports of substrate 1, optical-element integrated LSI 44 shown in FIG. 1C is fabricated. In this fabrication method, light-emitting device array 2 made up from a plurality of light-emitting devices 2a is mounted on substrate 1, following which unnecessary light-emitting devices 2a are removed to leave behind necessary light-emitting devices 2a. Optical output substrate 1A can thus be obtained in which light-emitting devices 2a are mounted as a group to all output ports despite the random arrangement of the plurality of output ports of substrate 1. As a result, the step of mounting light-emitting devices 2a is simplified, and this simplification contributes to lower costs. Further, because the heights of the light-emitting surfaces of the plurality of light-emitting devices 2a that make up light-emitting device array 2 are all aligned in advance, the light-emitting surfaces of the plurality of light-emitting devices 2a that are provided on optical output substrate 1A are all the same height. In this case, when optical-element integrated LSI 44 realized by mounting LSI 4 on optical output substrate 1A is optically coupled with optical circuits and optical signals then transmitted to and received from an outside LSI or memory, the optical signal incident surfaces of each of the optical circuits are normally aligned to a uniform height. Accordingly, the uniformity of the heights of the plurality of light-emitting devices 2a that are provided on optical output substrate 1A means that the spacing between each of light-emitting devices 2a and the plurality of optical circuit with which the light-emitting devices 2a are optically coupled can be kept uniform on all channels, and that highly efficient optical coupling can be realized between all light-emitting devices 2a and all optical circuits. In addition, the realization of highly efficient optical coupling means that the greater portion of the emergent light from each light-emitting device 2a can be directed to optical circuits, whereby the effects are obtained that optical signals can be transmitted over longer distances, and even when transmitted over short distances, optical signals can be transmitted with greater resistance to noise. Although explanation here regards one fabrication method, the other fabrication methods described hereinbelow can be used to fabricate optical output substrate 1A shown in FIGS. 1A and 1B. In addition, an optical-element integrated LSI can be fabricated by mounting an LSI on an optical output substrate that has been fabricated by the fabrication method described hereinbelow.

### Second Embodiment

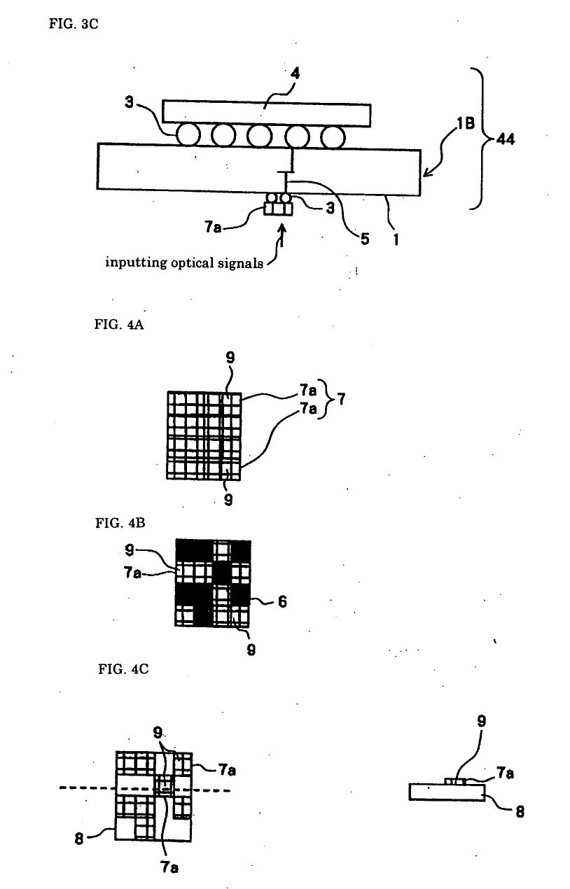

Explanation next regards an example of an optical input substrate and an optical-element integrated LSI of the present invention based on the accompanying figures. FIG. 3A is a schematic plan view showing the overall construction of optical input substrate 1B of this example, and FIG. 3B is a schematic sectional view of the overall construction of optical input substrate 1B. FIG. 3C is a schematic sectional view showing the overall construction of optical-element integrated LSI 44 of the present example.

In optical input substrate 1B of this example, photodetectors 7a are electrically connected by solder bumps 3 to input ports (not shown) that are formed on one surface (the rear surface in this example) of substrate 1. A plurality of input ports is present on the rear surface of substrate 1. These input ports are randomly arranged at various positions, and photodetectors 7a are mounted to each of the input ports. Devices capable of detecting light that is incident from the rear-surface side (downward in FIG. 3B) of substrate 1 are used for photodetectors 7a. Thus, when ON/OFF optical signals are received as input from the outside, these optical signals are converted to electrical signals by photodetectors 7a and supplied as ON/OFF electrical signals to the input ports of substrate 1.

LSI 4 is mounted on optical input substrate 1B shown in FIGS. 3A and 3B in optical-element integrated LSI 44 of this example. In addition, the electrical signal input ports (not shown) of LSI 4 are electrically connected by solder bumps 3 to the output ports (not shown) of substrate 1. As a result, LSI 4 and each of photodetectors 7a are electrically connected by way of electrical wiring of optical input substrate 1B. Thus, when ON/OFF optical signals are applied as input from the outside, these optical signals are converted to electrical signals by photodetectors 7a and then supplied as ON/OFF electrical signals to the electrical signal input ports of LSI 4.

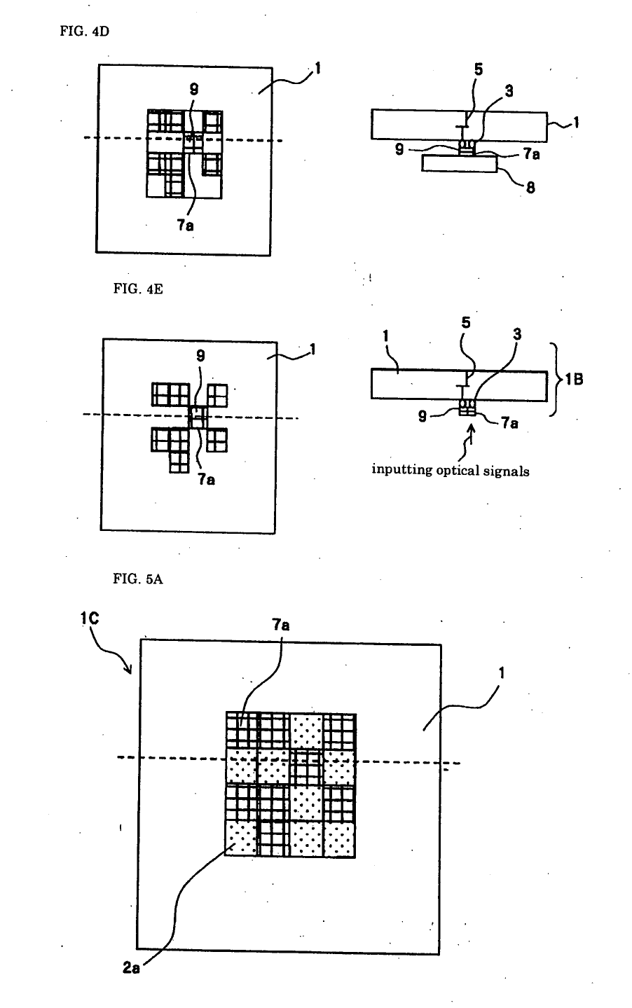

FIGS. 4A-4E show the fabrication method of optical input substrate 1B shown in FIGS. 3A and 3B. A fabrication method is here described that takes as an example substrate 1 having eight input ports, but the number of photodetectors can be increased or decreased as appropriate when the number of input ports is different.

First, as shown in FIG. 4A, photodetector array 7 is prepared in which photodetectors 7a are arranged in four rows and four columns on element substrate 8. Next, as shown in FIG. 4B, protective film 6 is formed to cover only necessary photodetectors 7a among the plurality of photodetectors 7a that makes up photodetector array 7. This example uses protective film 6 that is patterned by exposing and developing a resist. “Necessary photodetectors 7a” here indicates photodetectors 7a that are subsequently to be electrically connected to input ports of substrate 1.

Unnecessary photodetectors 7a are next removed by etching as shown in FIG. 4C. However, this etching step is performed such that only the functional portions (portions that are necessary for carrying out the functions of detecting optical signals, converting the detected optical signals to electrical signals, and supplying the electrical signals as output) 9 of the surfaces of unnecessary photodetectors 7a are etched, and such that element substrate 8 is not etched. This approach is adopted to use element substrate 8 as a support for all of the plurality of photodetectors 7a.

Protective film 6 is next removed to obtain photodetector array 7 in which only necessary photodetectors 7a have functional portions 9. Solder bumps 3 are next formed on the pads of each of photodetectors 7a that have functional portions 9 as shown in FIG. 4D, and these solder bumps 3 that have been formed are then used to electrically connect necessary photodetectors 7a to substrate 1.

By means of the above-described steps, optical input substrate 1B is fabricated in which photodetectors 7a are mounted on each of the plurality of input ports that are arranged at any position on substrate 1. LSI 4 is further mounted on optical input substrate 1B that has been fabricated and the electrical signal input ports of LSI 4 are electrically connected to the output ports of substrate 1 to fabricate optical-element integrated LSI 44 shown in FIG. 3C.

The fabrication method of the present example is characterized by mounting photodetector array 7, in which functional portions 9 of unnecessary photodetectors 7a have been removed in advance, on substrate 1, and then electrically connecting necessary photodetectors 7a and the input ports of substrate 1. Accordingly, optical input substrate 1B is obtained in which photodetectors 7a are mounted as a group on all input ports despite the random arrangement of the plurality of input ports of substrate 1. The fabrication steps of photodetectors 7a are therefore simplified, and this simplification contributes to lower costs. Further, because the heights of the photoreception surfaces of the plurality of photodetectors 7a that make up photodetector array 7 are aligned in advance, the photoreception surfaces of the plurality of photodetectors 7a that are provided on optical input substrate 1B are all the same height. When optical-element integrated LSI 44 obtained by mounting LSI 4 on optical input substrate 1B is optically coupled to optical circuits and optical signals are transmitted to and received from outside LSI or memory, the optical signal emergent surfaces of each of the optical circuits are normally aligned to a uniform height. Accordingly, the uniformity of the heights of the plurality of photodetectors 7a mounted on optical input substrate 1B means that the spacing between each of photodetectors 7a and the plurality of optical circuits with which these photodetectors 7a are optically coupled can be kept uniform on all channels and that highly efficient optical coupling can be realized between all photodetectors 7a and all optical circuits. Furthermore, the realization of highly efficient optical coupling means that the greater portion of emergent light from each optical circuit is detected by each photodetector 7a, whereby even a weak optical signal that was difficult or impossible to detect in the prior art can now be detected. For example, even a weak optical signal that has been attenuated due to long-distance transmission can be detected. Alternatively, because the greater portion of an optical signal having relatively strong light intensity can be photodetected by photodetectors 7a, transmission can be realized that is strongly resistance to noise. The latter effect is particularly conspicuous for transmission over short distances.

### Third Embodiment

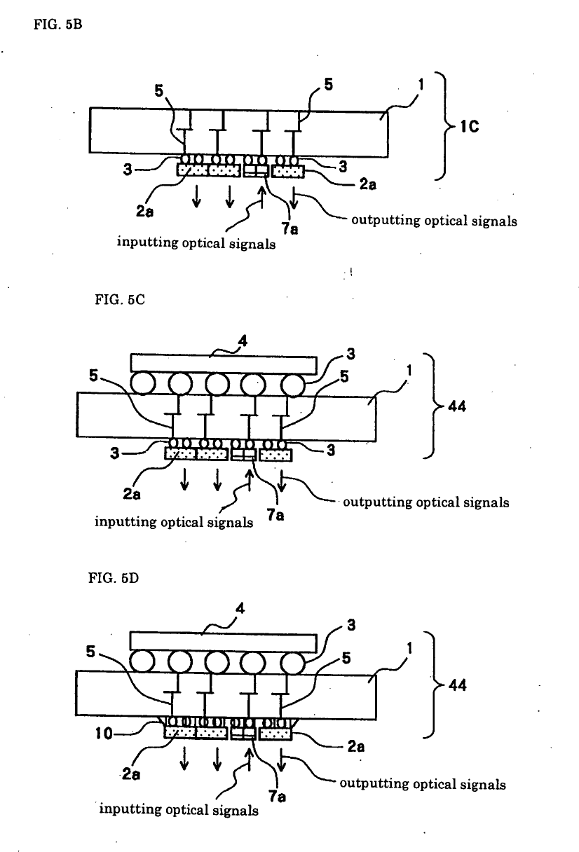

Explanation next regards the details of an example of the optical input/output substrate and optical-element integrated LSI of the present invention with reference to the accompanying figures. FIG. 5A is a schematic plan view showing the overall construction of the optical input/output substrate 1C of the present example, and FIG. 5B is a schematic sectional view of the overall construction of optical input/output substrate 1C. FIG. 5C is a schematic sectional view showing optical-element integrated LSI 44 of the present example.

In optical input/output substrate 1C of the present example, light-emitting devices 2a are electrically connected by solder bumps 3 to output ports (not shown) that are formed on one surface (the rear surface in this example) of substrate 1, and photodetectors 7a are electrically connected by solder bumps 3 to input ports (not shown). A plurality of output ports and input ports are present on the rear surface of substrate 1, and these ports are arranged randomly in various locations.

Devices capable of supplying light toward the rear-surface side (downward in FIG. 5B) of substrate 1 are used for light-emitting devices 2a. As a result, when ON/OFF electrical signals are supplied as output from output ports of substrate 1, these electrical signals are applied to light-emitting devices 2a and converted to optical signals and then supplied downward as optical signals.

Devices capable of photodetecting light incident from the rear-surface side (downward in FIG. 5B) of substrate 1 are used for photodetectors 7a. Accordingly, when ON/OFF optical signals are received as input from the outside, these optical signals are converted to electrical signals by photodetectors 7a and supplied as ON/OFF electrical signals to the input ports of substrate 1.

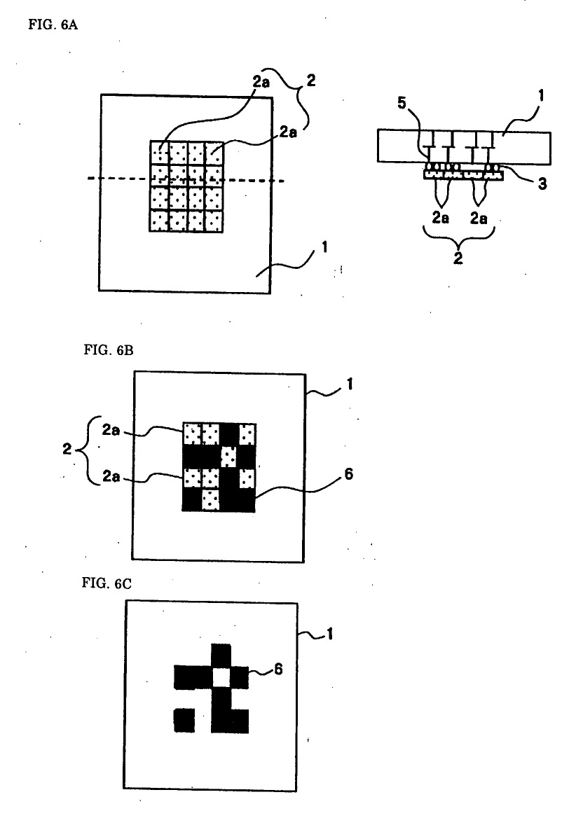

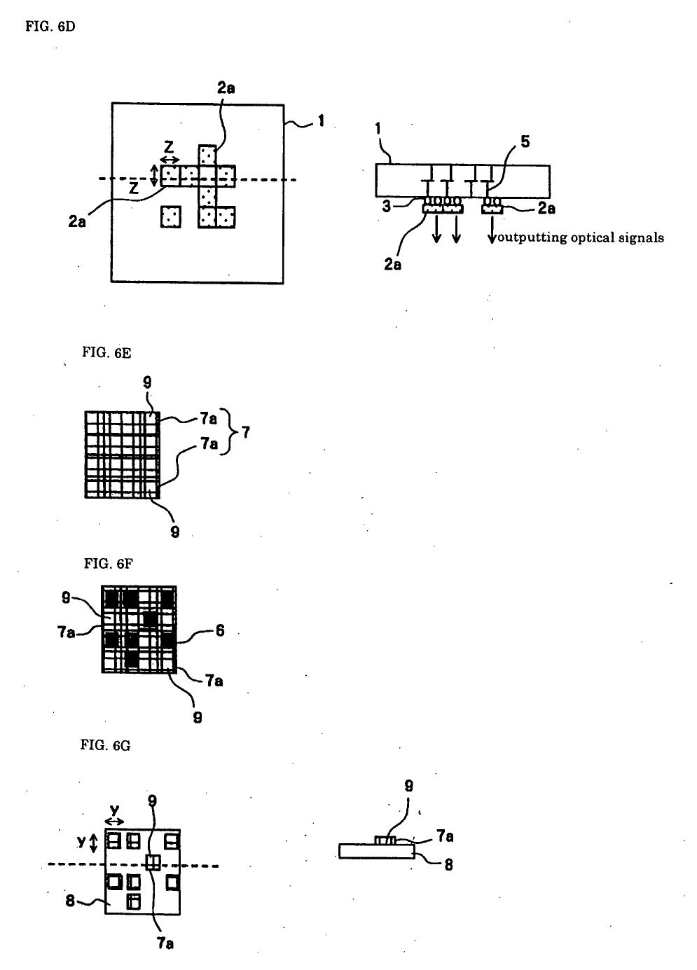

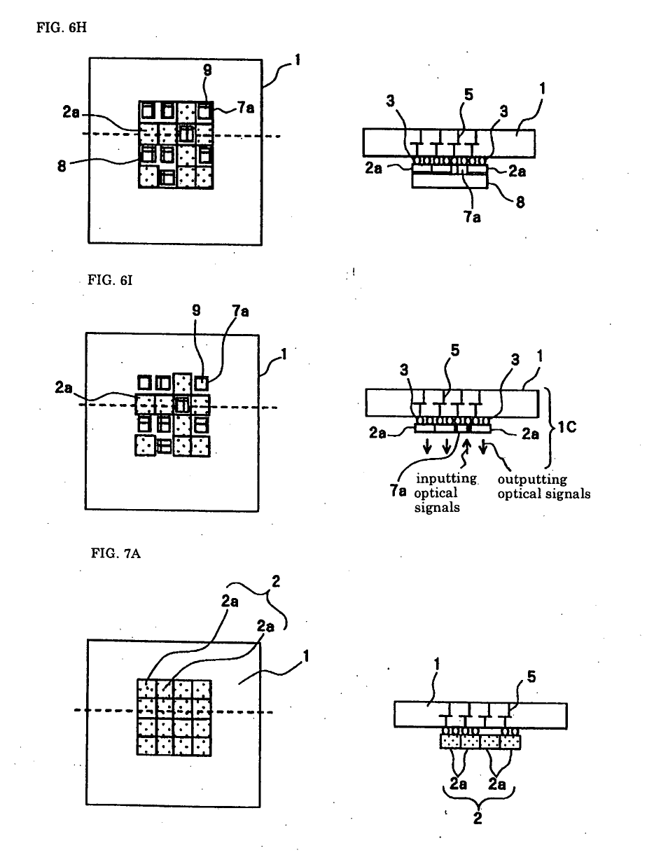

FIGS. 6A to 6I show the fabrication method of optical input/output substrate 1C shown in FIGS. 5A and 5B. This explanation of the fabrication method takes as an example substrate 1 provided with eight output ports and eight input ports, but the numbers of light-emitting devices and photodetectors can be modified as appropriate when the number of input/output ports differs.

As shown in FIG. 6A, light-emitting device array 2 is prepared in which light-emitting devices 2a are arranged in four rows and four columns on an element substrate. Solder bumps 3 are formed on the pads of necessary light-emitting devices 2a among the plurality of light-emitting devices 2a that makes up light-emitting device array 2, and these solder bumps 3 that have been formed are used to electrically connect light-emitting device array 2 to substrate 1. Here, “necessary light-emitting devices 2a” refers to light-emitting devices 2a that are to be electrically connected to output ports of substrate 1. Thus, although light-emitting devices 2a that are not to be electrically connected to output ports of substrate 1 are placed on substrate 1, these unnecessary light-emitting devices 2a are not electrically connected to substrate 1. In addition, the melting point of solder bumps 3 that are used for electrically connecting necessary light-emitting devices 2a to substrate 1 is higher than the melting point of solder bumps 3 that are subsequently used for electrically connecting necessary photodetectors 7a. This selective use of solder allows photodetectors 7a to be connected in the subsequent step for electrically connecting photodetectors 7a without melting the solder that connects light-emitting devices 2a.

Next, as shown in FIG. 6B, protective film 6 is formed to cover only necessary light-emitting devices 2a of light-emitting device array 2. This example uses protective film 6 that is patterned by exposing and developing a resist.

Next, as shown in FIG. 6C, unnecessary light-emitting devices 2a are removed by etching, following which protective film 6 is removed as shown in FIG. 6D.

The steps of mounting photodetectors 7a are next described while referring to FIGS. 6E to 6I. First, as shown in FIG. 6E, photodetector array 7 is prepared in which photodetectors 7a are arranged in four rows and four columns on element substrate 8.

Next, as shown in FIG. 6F, protective film 6 is formed to cover only necessary photodetectors 7a among the plurality of photodetectors 7a that makes up photodetector array 7. This example uses protective film 6 that is patterned by exposing and developing a resist. Here, “necessary photodetectors 7a” refers to photodetectors 7a that subsequently are to be electrically connected to input ports of substrate 1.

Unnecessary photodetectors 7a are next removed by etching as shown in FIG. 6G. In this etching step, however, etching is applied only to functional portions 9 of the surface of unnecessary photodetectors 7a, and etching is not applied to element substrate 8. This step is adopted to subsequently use element substrate 8 as a support for all of the plurality of photodetectors 7a. Protective film 6 is next removed to obtain photodetector array 7 in which only necessary photodetectors 7a have functional portions 9. Next, as shown in FIG. 6H, solder bumps 3 are formed on the pads of the plurality of photodetectors 7a that have functional portions 9, and these solder bumps 3 that have been formed are then used to electrically connect necessary photodetectors 7a to substrate 1.

Finally, as shown in FIG. 6I, element substrate 8 of photodetector array 7 is removed by etching.

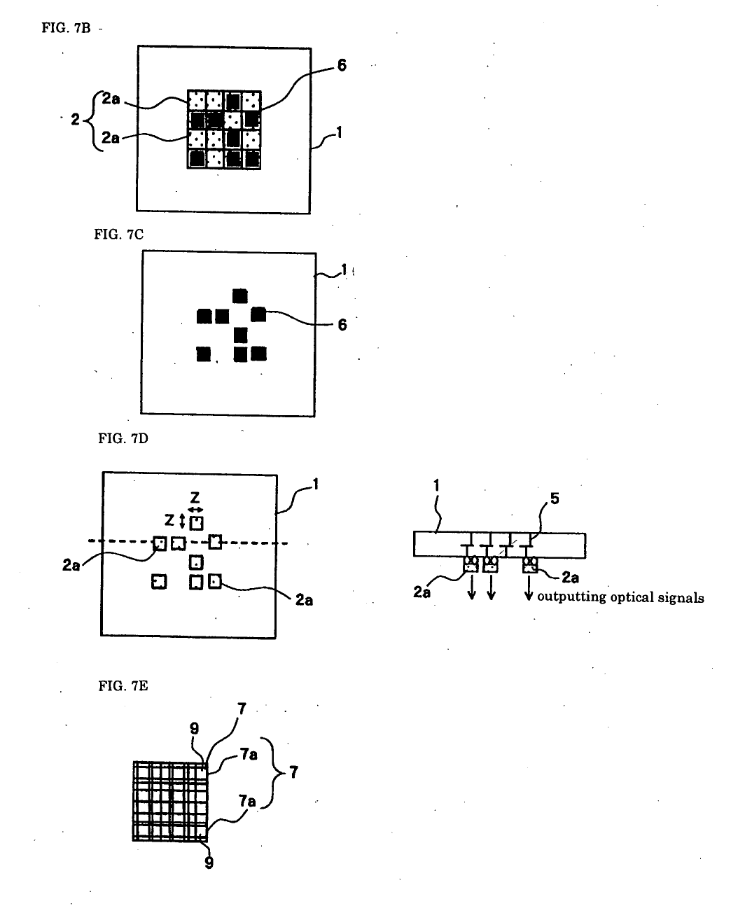

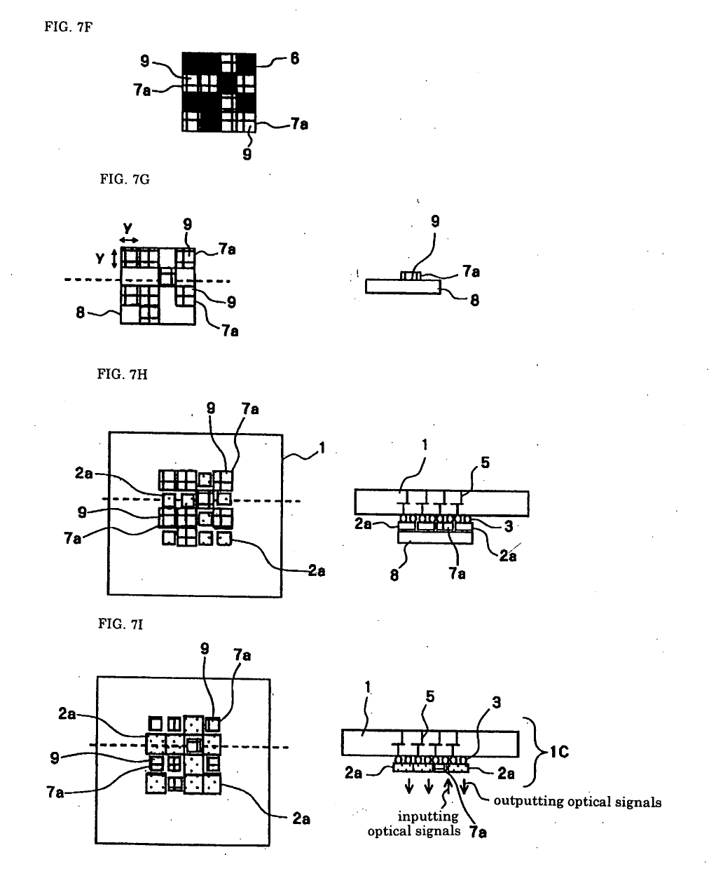

If the size of one channel of light-emitting device array 2 is “z” (refer to FIG. 6D) and the size of one channel of photodetector array 7 is “y” (refer to FIG. 6G), “y” is made smaller than “z” such that light-emitting devices 2a and photodetectors 7a do not interfere with each other at the time of the above-described assembly. Interference between light-emitting devices 2a and photodetectors 7a can also be circumvented if the above-described “z” is made smaller than the above-described “y.” FIGS. 7A-7I show an example in which interference between light-emitting devices 2a and photodetectors 7a is circumvented by making the above-described “z” smaller than the above-described “y.”

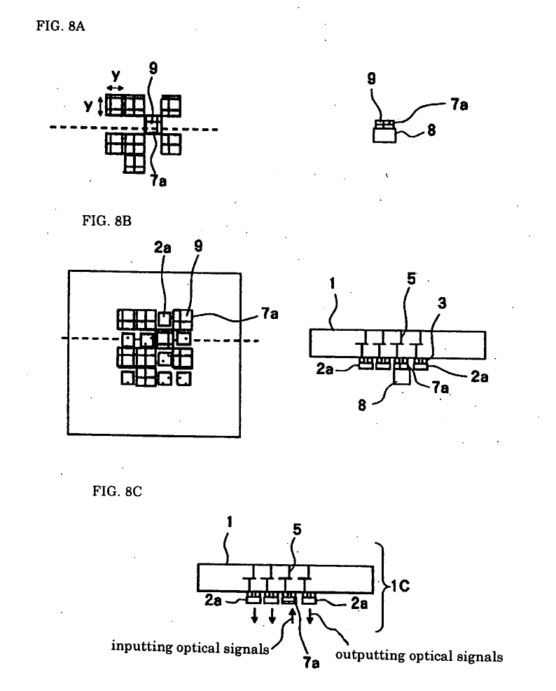

To this point, explanation has regarded a fabrication method of removing only the functional portions of unnecessary photodetectors among the plurality of photodetectors that makes up photodetector array and leaving the element substrate. However, as shown in FIGS. 8A-8C, unnecessary photodetectors 7a may also be etched together with element substrate 8. This fabrication method eliminates the need to regulate the thickness of light-emitting devices 2a, which are mounted first, to avoid interference between light-emitting devices 2a and element substrate 8. In addition, the steps shown in FIGS. 8A to 8C correspond to the steps shown in FIGS. 6G to 6I. Accordingly, optical input/output substrate 1C shown in FIGS. 5A and 5B can be fabricated by first executing the steps shown in FIGS. 6A-6F and then executing the steps shown in FIGS. 8A-8C.

By means of the above-described steps, optical input/output substrate 1C is fabricated in which light-emitting devices 2a and photodetectors 7a are mounted on each of a plurality of input/output ports arranged at any position on substrate 1. Further, by mounting LSI 4 on optical input/output substrate 1C that has been fabricated and by electrically connecting the electrical signal input ports of LSI 4 to the output ports of substrate 1 and electrically connecting the electrical signal output ports of LSI 4 to the input ports of substrate 1, optical-element integrated LSI 44 shown in FIG. 5C is fabricated. In the fabrication method of the present example, light-emitting device array 2 made up from a plurality of light-emitting devices 2a is mounted on substrate 1, following which unnecessary light-emitting devices 2a are removed to leave necessary light-emitting devices 2a, whereby light-emitting devices 2a can be mounted as a group to all output ports despite the random arrangement of the plurality of output ports of substrate 1. Accordingly, the step of mounting light-emitting devices 2A is simplified, and this simplification contributes to lower costs. Further, the heights of the light-emitting surfaces of the plurality of light-emitting devices 2a that makes up light-emitting device array 2 are aligned in advance, and as a result, the light-emitting surfaces of light-emitting devices 2a that have been mounted on each of the output ports of substrate 1 are all the same height. In this case, if optical-element integrated LSI 44 that is realized by mounting LSI 4 on optical input/output substrate 1C is optically coupled with optical circuits in order to transmit optical signals to an outside LSI or memory and in order to receive optical signals from an outside LSI or memory, the optical signal incident surfaces of each optical circuit are normally aligned to the same height. The uniformity of the heights of the plurality of light-emitting devices 2a that are mounted on substrate 1 means that the spacing between each of light-emitting devices 2a and the plurality of optical circuits that are optically coupled with these light-emitting devices 2a can be kept uniform on all channels, and further, that highly efficient optical coupling can be realized between all light-emitting devices 2a and all optical circuits. The realization of highly efficient optical coupling further means that the greater portion of emergent light from each of light-emitting devices 2a can be directed to optical circuits, whereby effects can be obtained by which the distance over which transmission is possible can be further extended and, even in the case of transmission over short distances, transmission having greater resistance to noise can be realized.

Furthermore, according to the fabrication method of the present example, photodetector array 7 in which the functional portions 9 of unnecessary photodetectors 7a have been removed in advance is mounted on substrate 1, following which necessary photodetectors 7a are electrically connected to input ports of substrate 1. Accordingly, photodetectors 7a can be mounted as a group to all input ports despite the random arrangement of the plurality of input ports of substrate 1. The step of mounting photodetectors 7a is thus simplified, and this simplification contributes to lower costs. In addition, the heights of the photoreception surfaces of the plurality of photodetectors 7a that makes up photodetector array 7 are aligned in advance, whereby the photoreception surfaces of the plurality of photodetectors 7a that are mounted on each of the input ports of substrate 1 are all the same height. When optical-element integrated LSI 44 realized by mounting LSI 4 on optical input/output substrate 1C is optically coupled with optical circuits in order to transmit optical signals to an outside LSI or memory and in order to receive optical signals from an outside LSI or memory, the optical signal emergent surfaces of each of the optical circuits are normally aligned to a uniform height. The uniformity of the heights of the plurality of photodetectors 7a that are mounted on substrate 1 means that the spacing between each of photodetectors 7a and the plurality of optical circuits with which these photodetectors 7a are optically coupled can be kept uniform for all channels, and further, that highly efficient optical coupling can be realized between all photodetectors 7a and all optical circuits. This realization of highly efficient optical coupling in turn means that the greater portion of emergent light from each optical circuit is received by each of photodetectors 7a, whereby even a weak optical signal that was difficult or impossible to receive in the prior art can now be received. For example, even a weak optical signal that has been attenuated by transmission over long distance can be received. Alternatively, because the greater portion of optical signals having relatively strong light intensity can be received by photodetectors 7a, transmission that is strongly resistance to noise can be realized. The latter effect is particularly conspicuous in transmission over short distances.

In general, an optical-element integrated LSI, fabricated by the fabrication method of the present example, is provided with a plurality of both light-emitting devices and photodetectors, and moreover, features uniform alignment of the heights of each of the light-emitting devices and photodetectors, and as a result, can obtain the effect that highly efficient optical coupling with optical circuits can be realized on all channels on the light-emitting side and photoreception side, and further, can obtain the effect that optical transmission can be performed under excellent conditions for both transmission and reception.

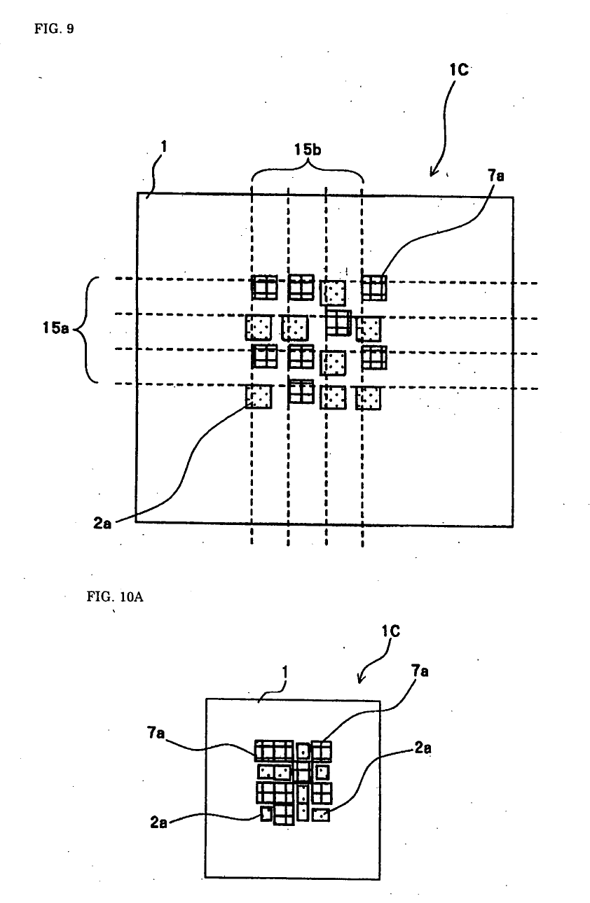

In addition, when a plurality of light-emitting devices and photodetectors are mounted in groups as in the fabrication method of the present example, the following effects are obtained. FIG. 9 is a schematic plan view of the optical input/output substrate 1C fabricated by the fabrication method of the present example. As shown in the figure, the actual mounting positions of photodetectors 7a are shifted upward from the prescribed mounting positions (shown by dotted lines 15a in the figure). In addition, the actual mounting positions of light-emitting devices 2a are shifted toward the left from the prescribed mounting positions (shown by dotted lines 15b in the figure). However, the pluralities of both photodetectors 7a and light-emitting devices 2a are mounted on substrate 1 in groups, and as a result, the direction and distance of divergence of the actual mounting positions with respect to the prescribed mounting positions are identical for optical elements of the same type. In other words, in FIG. 9, all photodetectors 7a are shifted upward and by the same distance from the prescribed mounting positions. Further, all light-emitting devices 2a are shifted toward the left and by the same distance from the prescribed mounting positions. In this case, highly efficient coupling can be realized if the entirety of optics components, i.e., the plurality of, for example, lenses (not shown in the figure) that correspond to photodetectors 7a, is shifted upward; and highly efficient coupling can be realized if the entirety of optics components that correspond to light-emitting devices 2a is shifted toward the left.

In an optical input/output substrate fabricated by the fabrication method of the present example in which pluralities of photodetectors and light-emitting devices are mounted in groups on a substrate, as described in the foregoing explanation, the positional divergence between the mounted positions of a plurality of optical elements of the same type and the designed mounting positions is the same direction, and moreover, is the same distance in the plurality of optical elements of the same type. As a result, shifting the positions of optical circuits that are to be optically coupled with the optical elements in the same direction and by the same distance as the positional shift of the optical elements produces the effect of enabling highly efficient optical coupling between the optical circuits and the plurality of optical elements of the same type. However, this effect is limited to a plurality of optical elements of the same type (in the case of FIG. 9, either optical coupling between light-emitting devices 2a and optical circuits, or optical coupling between photodetectors 7a and optical circuits). Of course, if the direction of divergence and the amount of divergence is identical for different types of optical elements, the effects of highly efficient coupling with optical circuits, and further, excellent optical communication, can be realized for both types. Still further, the melting point of the solder that is used for mounting optical elements in the first step is made high and the melting point of solder that is used for mounting optical elements in subsequent steps is made successively lower, whereby soldering can be executed in later steps at a temperature that does not melt the solder that was used in soldering at earlier steps. As a result, throughout all steps, solder that is used to secure optical elements is not melted again, whereby the effect is obtained that the original mounted positions are maintained without shifting of the positions of the optical elements. More specifically, when steps are taken such that the plurality of light-emitting devices are first mounted and the plurality of photodetectors are subsequently mounted, the melting point of the solder used in mounting the light-emitting devices is set higher than the melting point of the solder used in mounting the photodetectors, whereby the solder that was used in the mounting of the light-emitting devices does not melt during mounting of the photodetectors after the light-emitting devices have been mounted. The positions of the light-emitting devices therefore do not shift. Of course, the solder that is used in mounting the photodetectors melts, and the photodetectors can thus be secured to the prescribed mounting positions. This selective use of solder having different melting points obtains the effect of allowing the light-emitting devices and photodetectors to be secured to respective prescribed positions.

Further, as shown in FIG. 5D, underfill resin 10 can fill the gaps between substrate 1 and each of light-emitting devices 2a and photodetectors 7a and thus raise the connection strength between these components. The step of filling underfill resin 10 can be added at a suitable stage in the above-described fabrication steps.

### Fourth Embodiment

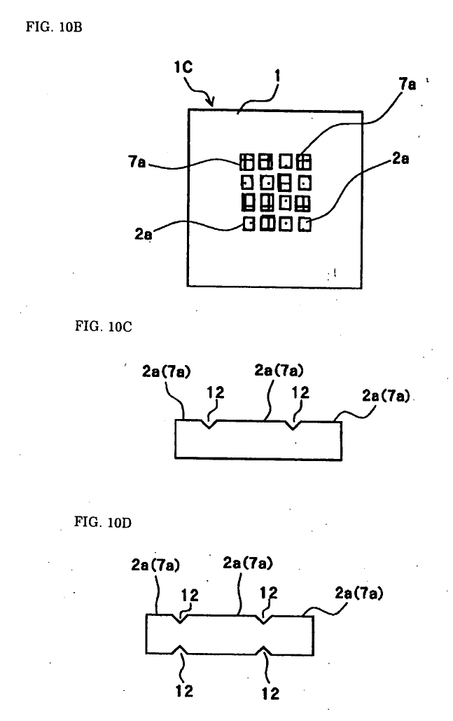

FIGS. 10A and 10B show another example of an optical input/output substrate of the present invention. In optical input/output substrate 1C shown in FIG. 10A, a part of adjacent photodetectors 7a are linked. When the portions of the electrode pattern of each photodetector 7a that makes up photodetector array 7 straddle two or more channels and cutting of the electrode pattern that straddles channels is not desired, the adoption of a structure such as shown in FIG. 10A is preferable. In FIG. 10A, an example is shown having both portions in which photodetectors 7a are linked together and portions in which photodetectors 7a are separated, and this state is also true of the light-emitting devices. In optical input/output substrate 1C shown in FIG. 10B, gaps are provided between adjacent light-emitting devices 2a and photodetectors 7a, and optical elements are isolated for each channel. When minimizing the stress that acts upon optical elements due to the effect of thermal expansion, the adoption of a structure such as shown in FIG. 10B is preferable. As one example of a method that can be considered for providing gaps between adjacent optical elements, as shown in FIG. 10B, to facilitate separation between adjacent optical elements, grooves 12 introduced between adjacent optical elements as shown in FIG. 10C or 10D. FIGS. 1C and 10D give schematic representations of the profiles of optical elements. In FIG. 10C, grooves 12 are introduced in the surface of one side of the optical element, and in FIG. 10D, grooves 12 are introduced in the surfaces on both sides of the optical element.

As described in the foregoing explanation, the adoption of a structure in which a plurality of the optical elements that are mounted on a substrate are linked obtains the effects of allowing the sharing of electrode wiring between adjacent optical elements, increasing the degree of freedom of wiring layout, and further, increasing the degree of freedom in the arrangement of solder on electrodes for mounting. On the other hand, the adoption of a structure in which optical elements are separated for each channel obtains the effects of enabling a decrease of the size of optical elements of structural units and enabling a reduction of the stress applied to optical elements as a result of differences in the thermal expansion coefficients between the substrate and optical element.

### Fifth Embodiment

FIGS. 11A and 11B show another example of an optical input/output substrate of the present invention. In optical input/output substrate 1C shown in FIG. 11A, the heights of a plurality of photodetectors 7a are uniform with respect to substrate 1, and the heights of the plurality of light-emitting devices 2a are also uniform with respect to substrate 1. However, the height of light-emitting devices 2a differs from the height of photodetectors 7a. Optical input/output substrate 1C such as shown in FIG. 11A can be fabricated by mounting light-emitting devices 2a on substrate 1 and then by mounting photodetectors 7a on substrate 1. At this time, the thickness of photodetectors 7a can be made greater than that of light-emitting devices 2a to enable mounting in which interference is avoided between light-emitting devices 2a and photodetectors 7a.

In optical input/output substrate 1C shown in FIG. 11B, the heights of a plurality of photodetectors 7a and light-emitting devices 2a are uniform with respect to substrate 1. In other words, the heights of all optical elements are the same. Optical input/output substrate 1C such as shown in FIG. 11B can be fabricated by first fabricating optical input/output substrate 1C having the structure such as shown FIG. 11A and then by etching thick optical elements (photodetectors 7a in FIG. 11A) to align with thin optical elements (light-emitting devices 2a in FIG. 11A).

As shown in FIGS. 11A and 11B, the advantages obtained by aligning the heights of mounted optical elements have been explained repeatedly, and redundant explanation is therefore here omitted.

### Sixth Embodiment

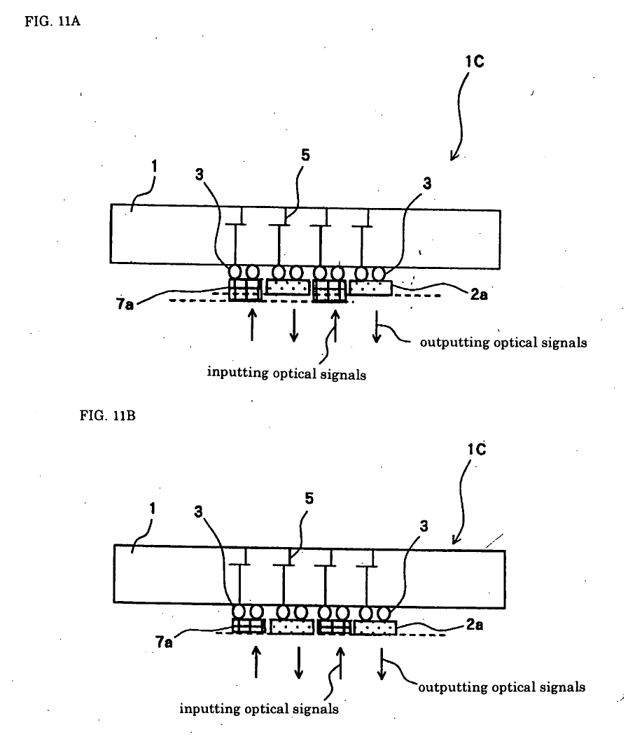

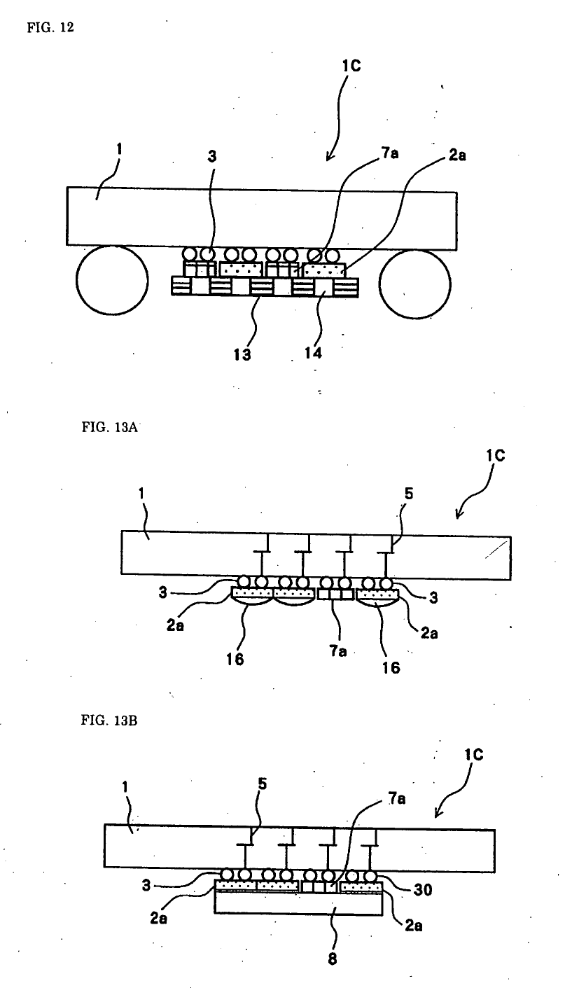

FIG. 12 shows another example of an optical input/output substrate of the present invention. In optical input/output substrate 1C shown in FIG. 12, a plurality of light-emitting devices 2a and photodetectors 7a are mounted on substrate 1 by means of solder bumps 3, and heat sinks 13 are provided in the vicinities of these light-emitting devices 2a and photodetectors 7a. Various materials such as aluminum, copper, and silicon can be used as the material of heat sinks 13. Although no problems occur when the material of heat sinks 13 is optically transparent to the wavelength of the input and output light of light-emitting devices 2a and photodetectors 7a, windows 14 must be formed to ensure light paths when the material of heat sinks 13 is not transparent. It is well known that optical elements such as photodetectors or light-emitting devices exhibit degraded performance at high temperatures compared to normal temperatures. In optical input/output substrate 1C of the present example, however, the provision of heat sinks 13 in the vicinities of light-emitting devices 2a and photodetectors 7a enables the discharge of heat generated from light-emitting devices 2a and photodetectors 7a and allows light-emitting devices 2a and photodetectors 7a to be driven at a temperature close to normal temperature. As a result, the performance of light-emitting devices 2a and photodetectors 7a is adequate. The further provision of similar heat sinks in the surface of substrate 1 enables an even greater heat discharge effect.

### Seventh Embodiment

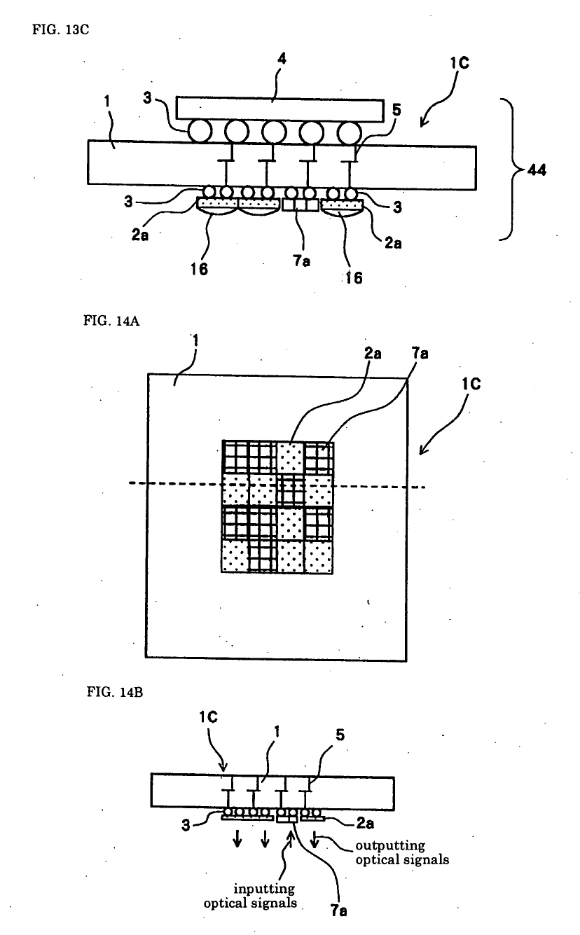

FIG. 13A shows another example of an optical input/output substrate of the present invention. In optical input/output substrate 1C shown in FIG. 13A, light-emitting devices 2a are mounted on each output port of substrate 1 and photodetectors 7a are mounted on each input port. In addition, lenses 16 are integrated with all or a portion of light-emitting devices 2a that are mounted. The focusing action of lenses 16 collimates or suppresses the divergence of light that is emitted from light-emitting devices 2a, and thus facilitates the highly efficient optical coupling with optics components that are the objects of coupling. If necessary, lenses can also be integrated with photodetectors 7a. The trend toward higher speeds in photodetectors has been accompanied by the miniaturization of the photoreception parts of photodetectors, and the integration of lenses in photodetectors 7a is therefore effective for realizing highly efficient optical coupling. The method of integrating lenses with light-emitting devices 2a or photodetectors 7a include methods in which element substrate 8, on which photodetectors 7a are formed as shown in FIG. 13B, is etched to a convex shape; and methods in which a polymer is applied to light-emitting devices 2a or photodetectors 7a and then allowed to cure, taking advantage of the surface tension of the polymer to form the lens shape. As described hereinabove, the provision of lenses in optical elements can suppress the divergence of light that is emitted from optical elements or from optical circuits. Alternatively, the light can be converted to parallel rays depending on the characteristics of optics such as lenses. As a result, highly efficient optical coupling is realized even when the distance between the optical element and optical circuit is somewhat remote. Alternatively, the effects of enabling highly efficient optical coupling and excellent optical communication are obtained even when the area of the photoreception part of a photodetector is small or when the size of the optical propagation part (normally referred to as the “core”) of an optical circuit is small.

FIG. 13C shows another example of an optical-element integrated LSI of the present invention. Optical-element integrated LSI 44 shown in FIG. 13C is realized by mounting LSI 4 on optical input/output substrate 1C shown in FIG. 13A by way of solder bumps 3. The electrical signal input ports of optical-element integrated LSI 44 that has been mounted are electrically connected to the output ports of substrate 1, and the electrical signal output ports of optical-element integrated LSI 44 are electrically connected to the input ports of substrate 1.

### Eighth Embodiment

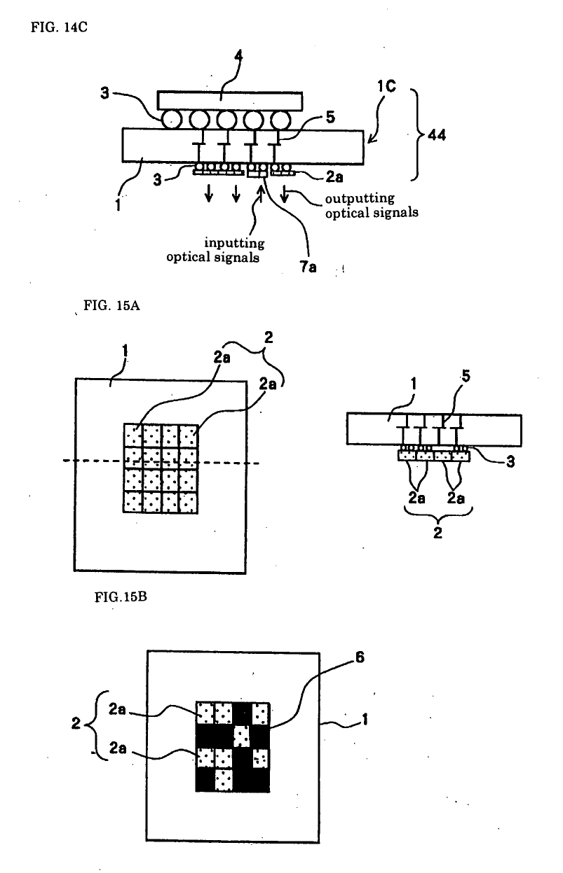

FIG. 14A and FIG. 14B show another example of an optical input/output substrate of the present invention. In optical input/output substrate 1C shown in FIGS. 14A and 14B, a plurality of light-emitting devices 2a and photodetectors 7a are mounted on substrate 1. In this case, explanation regards an example in which eight output ports and eight input ports are provided on substrate 1, but the numbers of light-emitting devices and photodetectors can be modified as appropriate when the number of input/output ports is different. In this example, light-emitting devices 2a and photodetectors 7a are made into thin-films leaving the functional portions. Here, the “functional portions” of photodetectors 7a are the same as previously described. The “functional portions” of light-emitting devices 2a refer to those portions necessary for performing the functions of converting electrical signal that are received as input to optical signals and supplying these optical signal to the outside.

Converting light-emitting devices 2a and photodetectors 7a to thin-films as described hereinabove enables a shortening of the distance between these optical elements and the targets of optical coupling, and enables an improvement in coupling efficiency and the permissible amount of positional shift. The conversion to thin-film eliminates a portion of the substrate of the optical elements and can eliminate the loss that occurs when light passes through the substrate.

FIG. 14C shows another example of the optical-element integrated LSI of the present invention. The optical-element integrated LSI shown in FIG. 14C is realized by mounting LSI 4 on optical input/output substrate 1C shown in FIG. 14A and FIG. 14B by way of solder bumps 3. The electrical signal input ports of LSI 4 that has been mounted are electrically connected to the output ports of substrate 1, and the electrical signal output ports of LSI 4 are electrically connected to the input ports of substrate 1.

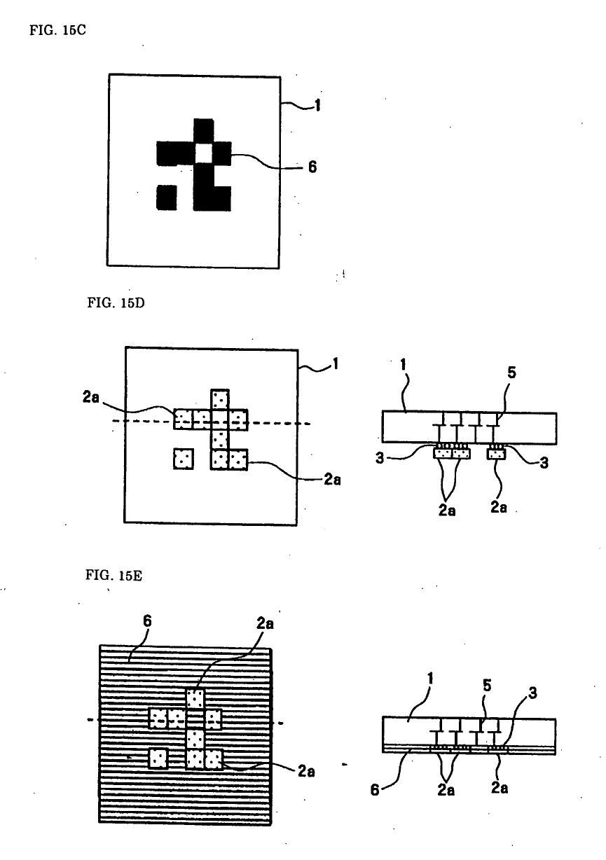

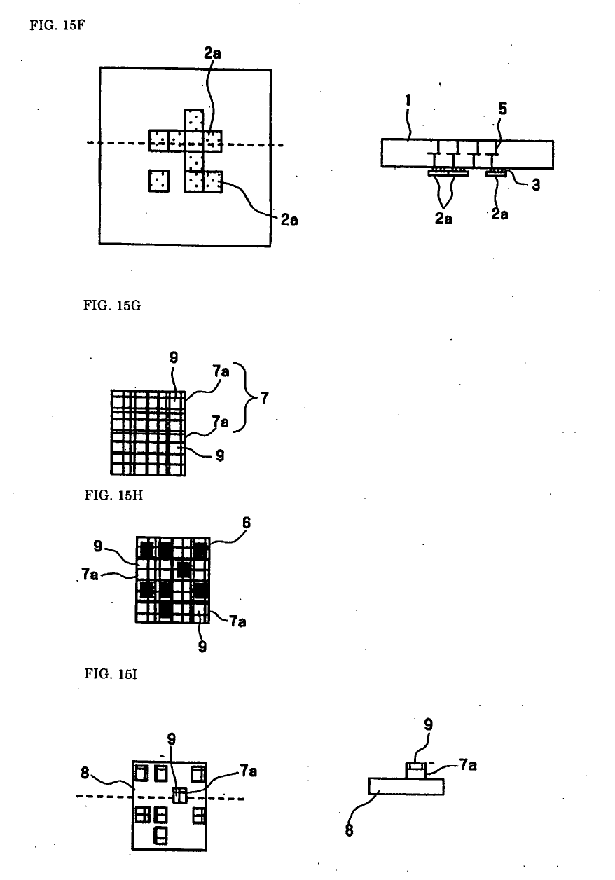

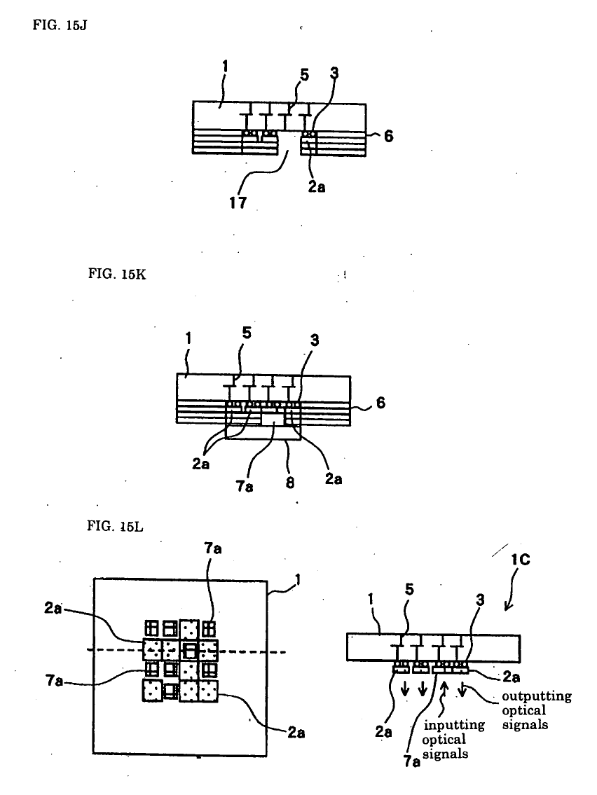

FIGS. 15A-15L show the fabrication method of optical input/output substrate 1C shown in FIGS. 14A and 14B. First, as shown in FIG. 15A, light-emitting device array 2 is prepared in which light-emitting devices 2a are arranged in four rows and four columns on element substrate (not shown). Solder bumps 3 are formed only on the pads of necessary light-emitting devices 2a among the light-emitting device array 2, and these solder bumps 3 that have been formed are used to electrically connect light-emitting device array 2 to substrate 1. In this case, “necessary light-emitting devices 2a” means those light-emitting devices 2a that are to be electrically connected to output ports of substrate 1.

Next, as shown in FIG. 15B, protective film 6 is formed to cover only necessary light-emitting devices 2a in light-emitting device array 2. This example uses protective film 6 that is patterned by exposing and developing a resist.

Next, as shown in FIG. 15C, unnecessary light-emitting devices 2a are removed by etching. Protective film 6 is then removed as shown in FIG. 15D, whereby light-emitting devices 2a are mounted only at necessary positions. Next, as shown in FIG. 15E, the surface of substrate 1 on which light-emitting devices 2a are not mounted is covered by protective film 6, following which the element substrate of light-emitting devices 2a is etched to make light-emitting devices 2a thin-film. Protective film 6 is next removed, as shown in FIG. 15F.

Photodetector array 7 is next prepared in which photodetectors 7a are arranged in four rows and four columns on element substrate 8, as shown in FIG. 15G. Next, as shown in FIG. 15H, protective film 6 is formed to cover only necessary photodetectors 7a. This example uses protective film 6 that is patterned by exposing and developing a resist. Here, “necessary photodetectors 7a” means photodetectors 7a that subsequently are to be electrically connected to substrate 1.

Unnecessary photodetectors 7a are next removed by etching as shown in FIG. 15I. In this etching step, etching is applied to both the surfaces of photodetectors 7a and to portions of the surfaces of element substrate 8 but not to all of element substrate 8 in order to leave a part of the surface of element substrate 8. This method is adopted to use element substrate 8 as a support for the entirety of the plurality of photodetectors 7a. Protective film 6 is then removed to obtain photodetector array 7 in which photodetectors 7a are left only at necessary positions. Solder bumps 3 are further formed on the pads of the remaining plurality of photodetectors 7a.

Next, as shown in FIG. 15J, openings 17 that communicate with the input ports, to which photodetectors 7a are to be electrically connected, are provided on substrate 1 on which light-emitting devices 2a have already been mounted; and the other portions are covered by protective film 6. Photodetector array 7 is then placed on substrate 1 such that each of photodetectors 7a of photodetector array 7 is inserted into a corresponding opening 17, whereby the plurality of photodetectors 7a is mounted as a group. Next, as shown in FIG. 15L, element substrate 8 of photodetector array 7 is etched, following which protective film 6 that is provided on the substrate 1 side is removed.

As another fabrication method, unnecessary light-emitting devices 2a among the plurality of light-emitting devices 2a that makes up light-emitting device array 2 are first removed, following which light-emitting devices 2a are mounted on output ports of substrate 1. Photodetectors 7a can be mounted by a method similar to the method described above.

Optical input/output substrate 1C provided with optical elements that have been made into thin-film can be fabricated by the fabrication method described hereinabove. If LSI 4 is further mounted on optical input/output substrate 1C that has been fabricated, optical-element integrated LSI 44 shown in FIG. 14C is fabricated. The distance between the functional portions of the optical elements and the optical circuits that are optically coupled with these functional portions is shortened by means of optical input/output substrate 1C that is provided with optical elements that have been made into thin-film, whereby the effects are obtained that the optical signals that are emitted from the light-emitting devices or the optical circuits can be coupled with optical circuits or photodetectors before spreading appreciably, and the optical coupling efficiency thus raised.

### Ninth Embodiment

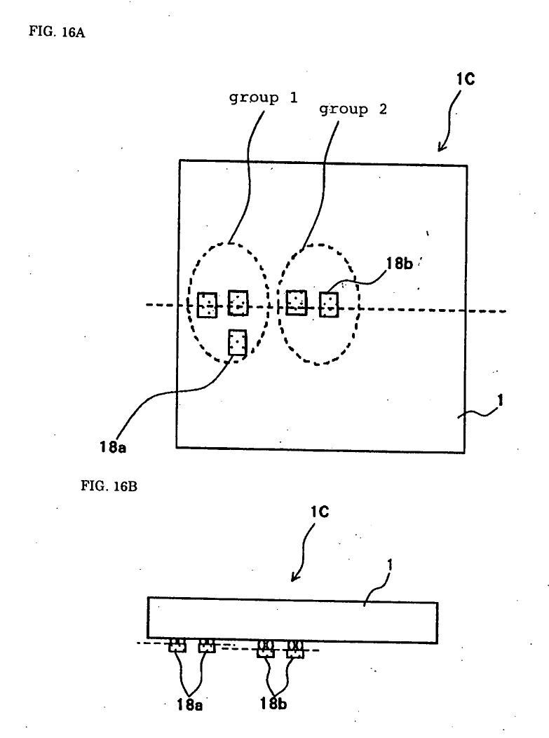

FIGS. 16A and 16B show another example of the optical input/output substrate of the present invention. In optical input/output substrate 1C shown in FIGS. 16A and 16B, five optical elements are mounted on substrate 1. Of these, three optical elements 18a are collected in a portion oriented to the left of substrate 1 and these are referred to as group 1. The remaining two optical elements 18b are collected in substantially the center of substrate 1, and these are referred to as group 2.

The three optical elements 18a that belong to group 1 have uniform heights, and the two optical elements 18b that belong to group 2 also have uniform heights. However, the height of optical elements 18a is lower than that of optical elements 18b. Accordingly, when the positions of optical fibers (not shown) that are optically coupled with optical elements 18a that belong to group 1 are higher than the positions of optical fibers (not shown) that are optically coupled with optical elements 18b that belong to group 2, the distance between the optical fibers and optical elements 18a that belong to group 1 can be made substantially equal to the distance between the optical fibers and optical elements 18b that belong to group 2 by making the height of optical elements 18a that belong to group 1 lower than the height of optical elements 18b that belong to group 2, whereby optical coupling can be realized that, on average, has high efficiency.

As described above, in the case of different heights of the optical circuit groups that are to be optically coupled to optical elements that belong to each group, setting the heights of the optical elements that belong to each group to match the heights of the corresponding optical circuit groups obtains the effects of enabling realization of highly efficient optical coupling between optical circuits and the optical elements that belong to each group and of enabling the provision of excellent optical communication.

### Tenth Embodiment

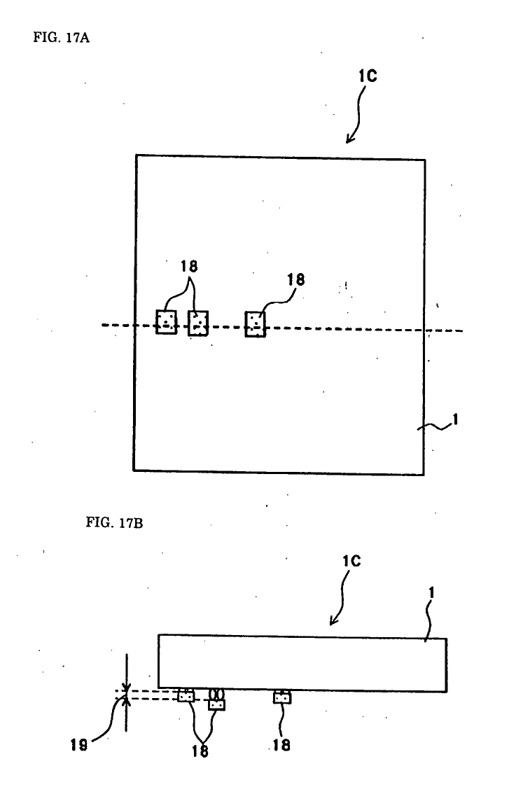

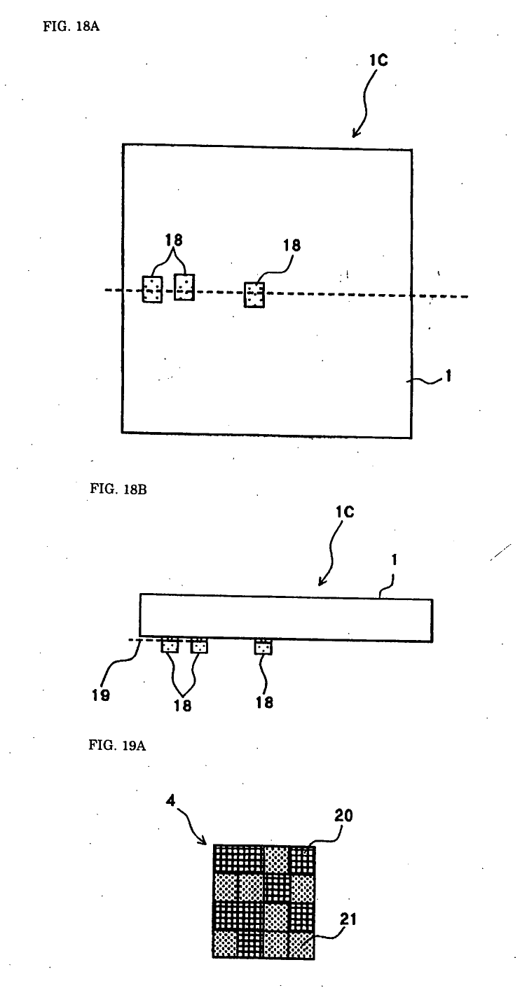

FIGS. 17A and 17B and FIGS. 18A and 18B show another example of the optical input/output substrate of the present invention. Optical input/output substrate 1C shown in FIGS. 17A and 17B is fabricated by a fabrication method of the prior art in which a plurality of optical elements 18 are individually mounted. Optical input/output substrate 1C shown in FIGS. 18A and 18B is a device fabricated by the fabrication method of the present invention in which a plurality of optical elements 18 are mounted as a group. In optical input/output substrate 1C shown in FIGS. 17A and 17B, divergence 19 in the heights between adjacent optical elements 18 is on the order of 2 μm if the height of substrate 1 is taken as a reference, and the divergence in heights frequently surpasses this level due to the conditions of the devices. On the other hand, in optical input/output substrate 1C shown in FIG. 18A and FIG. 18B, the divergence in heights 19 between adjacent optical elements 18 is suppressed to the order of 0.5 μm. It can be seen that, compared to the divergence of 2 μm described above, the divergence in height has been greatly reduced. This reduction is realized because, in the fabrication method of the present invention, a plurality of necessary optical elements are batch-mounted by mounting an optical element array that is composed of a plurality of optical elements and then by removing unnecessary optical elements, or a plurality of necessary optical elements are batch-mounted by mounting an optical element array from which unnecessary optical elements have been removed in advance. As a further effect, compared to a case in which optical elements are mounted one at a time, mounting a plurality of optical elements as a group enables a reduction of the time required for mounting as well as a reduction of cost. This effect becomes more conspicuous as the number of optical elements that are mounted increases.

### Eleventh Embodiment

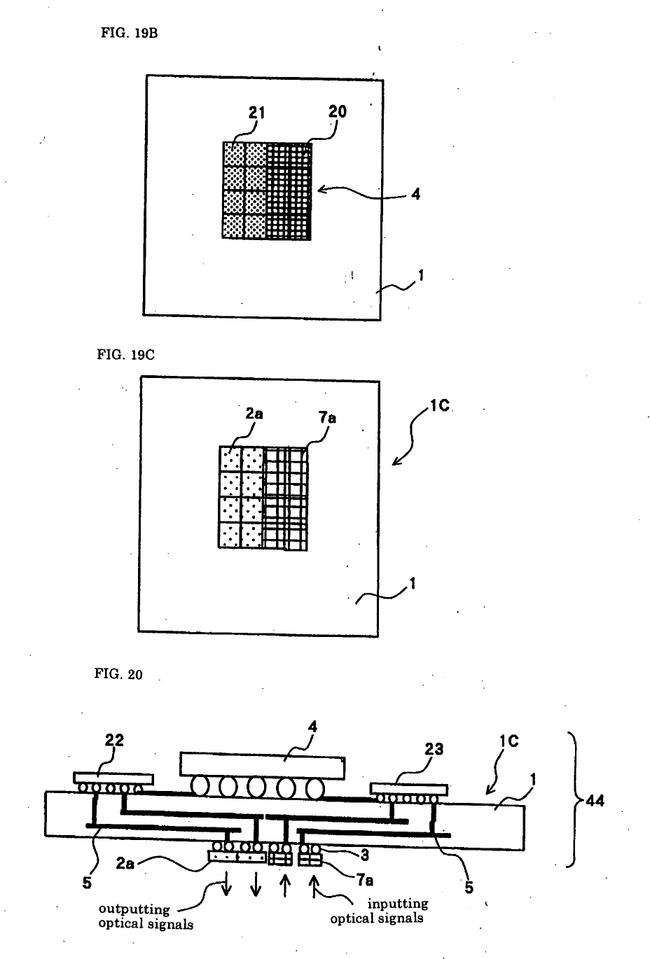

FIGS. 19A-19C show another example of a fabrication method of the optical input/output substrate of the present invention. As shown in FIG. 19A, LSI 4 that is used in the present example has electrical signal input ports 20 for four channels and electrical signal output ports 21 for four channels, and these eight channels of input/output ports are randomly arranged at various positions. As shown in FIG. 19B, in the fabrication method of the present example, solder is used to mount LSI 4 on substrate 1 in which electrical wiring (not shown) has been formed on an inner layer, and electrical signal input ports 20 and electrical signal output ports 21 of LSI 4 are rearranged as shown in the same figure. More specifically, the input/output ports are rearranged such that electrical signal input ports 20 are collected on the right half of LSI 4, and electrical signal output ports 21 are collected on the left half of LSI 4. Photodetector array 7 in which photodetectors 7a are formed in four rows and two columns is next mounted on electrical signal input ports 20 that have been rearranged as shown in FIG. 19C. In addition, light-emitting device array 2 in which light-emitting devices 2a are formed in four rows and two columns is mounted on electrical signal output ports 21 that have been rearranged. By means of these steps, light-receiving and light-emitting optical elements are mounted on each of the input/output ports of LSI 4 to enable the exchange of optical signal with the outside. In addition, the pluralities of light-emitting devices 2a and photodetectors 7a are each mounted in groups and have aligned heights.

As described in the foregoing explanation, by using the electrical wiring of a substrate to rearrange the electrical signal input/output ports of an LSI that are randomly arranged, the electrical signal input/output ports can be collected in one location and optical elements can then be mounted. As a result, a plurality of optical elements can be mounted as a group to a plurality of corresponding ports to realize a decrease in the number of fabrication steps and a reduction of costs. In addition, in contrast to mounting optical elements separately, the heights of optical elements of the same type can be uniformly aligned. Still further, the optical circuits that are optically coupled to optical elements can be divided between an input side and an output side to simplify design. In addition, separating the transmission side and reception side obtains the effect of reducing crosstalk between transmission and reception.

### Twelfth Embodiment

FIG. 20 shows another example of an optical-element integrated LSI of the present invention. In optical-element integrated LSI 44 shown in FIG. 20, the basic configuration in which LSI 4 is mounted on optical input/output substrate 1C is common to the optical-element integrated LSI that have been described. As the point of difference in this case, driver IC 22 and amplifier 23 are mounted on substrate 1. More specifically, the electrical signal output ports of LSI 4 are electrically connected to driver IC 22, and driver IC 22 is electrically connected to light-emitting devices 2a. In addition, the electrical signal input ports of LSI 4 are electrically connected to amplifier 23, and amplifier 23 is electrically connected to photodetectors 7a.

Depending on the type of optical element, the use of the driver IC or amplifier exhibits superior performance. For example, the use of the driver IC increases in some cases the amount of emitted light of the light-emitting devices, and the use of the amplifier amplifies optical signals (electrical signals) of the photodetectors to larger signals in some cases. When using optical elements having the above-described characteristics, the adoption of a construction such as shown in FIG. 20 is preferable.

### Thirteenth Embodiment

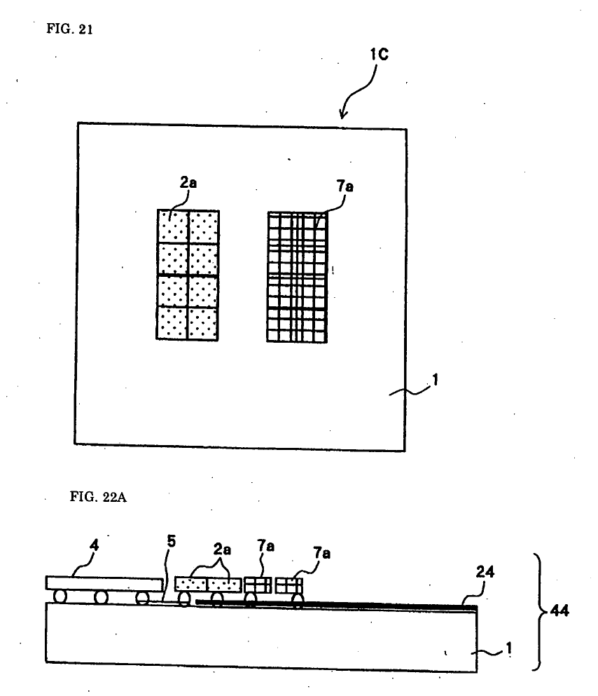

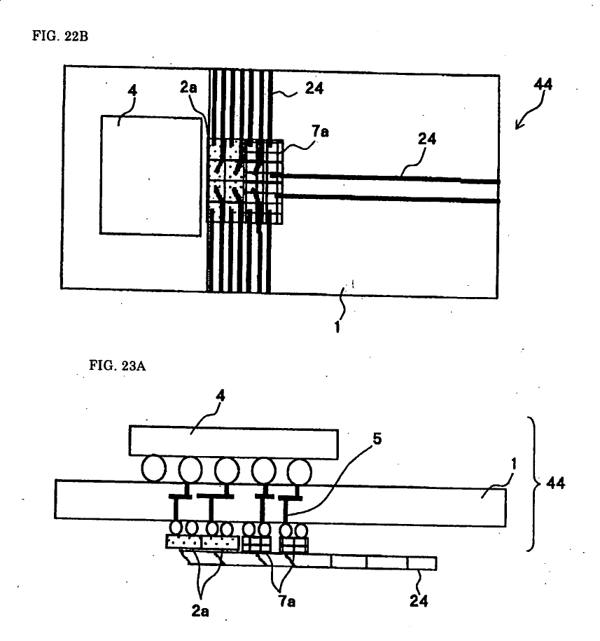

When the electrical signal input/output ports of an LSI are close to each other, electrical interference may occur between input and output signals and thus disturb the signals. Accordingly, the input/output ports of the LSI may be separated to decrease crosstalk. In optical input/output substrate 1C of the present invention, light-emitting devices 2a and photodetectors 7a can be mounted on substrate 1 separated by at least a fixed distance such as shown in FIG. 21 for application to an LSI in which the input/output ports are separated.

### Fourteenth Embodiment

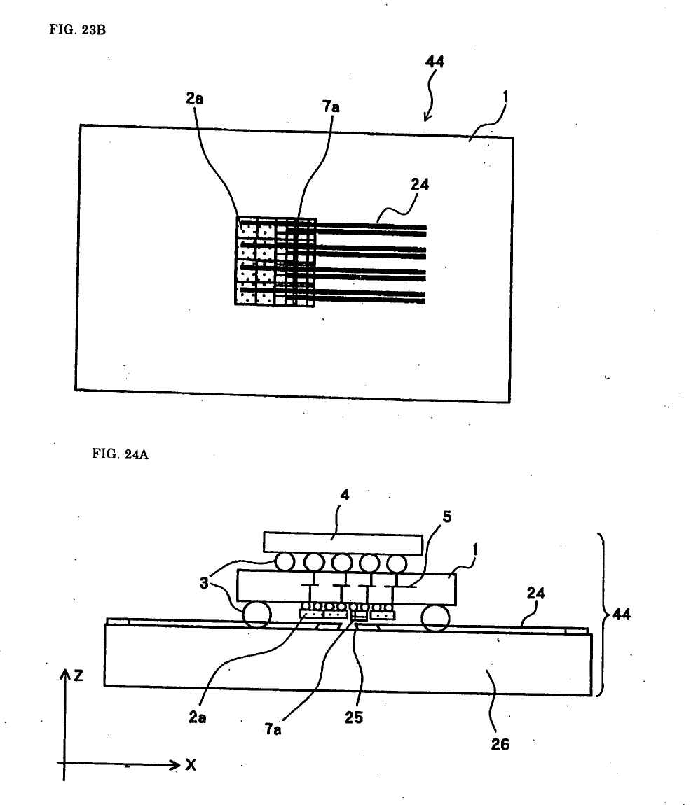

FIGS. 22A and 22B show another example of an optical-element integrated LSI of the present invention. In optical-element integrated LSI 44 shown in FIGS. 22A and 22B, LSI 4, light-emitting devices 2a, and photodetectors 7a are mounted on the same surface of substrate 1. LSI 4 is further electrically connected to light-emitting devices 2a and photodetectors 7a by electrical wiring 5 that is formed on substrate 1. Still further, optical waveguides 24 are also formed on the surface of substrate 1 on which LSI 4 and other components are mounted, and light-emitting devices 2a and photodetectors 7a are optically coupled with optical waveguides 24 by way of mirrors (not shown) provided on the end surfaces of optical waveguides 24. The electrical signal input/output ports of LSI 4 shown in FIGS. 22A and 22B are further rearranged by the method described in the eleventh embodiment.

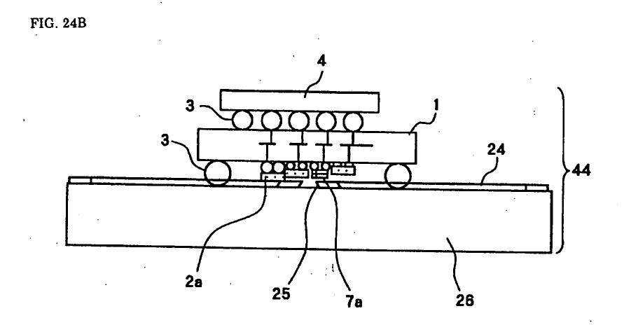

The formation, on the same surface of the same substrate, of optical waveguides that are optically coupled with optical elements mounted on the substrate as described hereinabove obtains the effect of realizing highly efficient optical coupling between the optical elements and optical waveguides. In optical-element integrated LSI 44 shown in FIGS. 23A and 23B, LSI 4 is mounted on one surface of substrate 1, and on the other surface of substrate 1, light-emitting devices 2a and photodetectors 7a are mounted and optical waveguides 24 are formed. By means of this construction, one surface of substrate 1 can be used mainly as the area for forming electrical wiring, and the other surface can be used mainly as the area for forming optical interconnections to thus enable high-density packaging. In addition, by differentiating the wavelengths of the output light of two light-emitting devices 2a, two light-emitting devices 2a can be optically coupled with the same optical waveguide 24. Further, by differentiating, between two photodetectors, the wavelengths of light that can be photodetected by photodetectors 7a, two photodetectors 7a can be optically coupled to the same optical waveguide 24. The adoption of this configuration enables high-capacity transmission by wavelength division multiplex communication, and enables a further increase in the number of multiplexed wavelengths to realize even greater transmission capacity.

### Fifteenth Embodiment

FIGS. 24A and 24B shows the sectional construction when optical-element integrated LSI 44 of the present invention is mounted on optoelectrical hybrid substrate 26 on which optical waveguides 24, optical waveguide end-surface mirrors 25, and electrical wiring have been formed. In this case, “optoelectrical hybrid substrate 27” refers to a substrate that is provided with both optical circuits and electrical circuits. FIGS. 24A and 24B show an example that uses optical waveguides 24 as the optical circuits, but optical fiber may be used as another optical circuit. FIG. 24A shows the sectional construction when optical-element integrated LSI 44 of the present invention is mounted on optoelectrical hybrid substrate 26, and FIG. 24B shows the sectional construction when an optical-element integrated LSI fabricated by the method of the prior art is mounted on optoelectrical hybrid substrate 26. Optical-element integrated LSI 44 shown in FIG. 24A and the optical-element integrated LSI shown in FIG. 24B share the common feature that LSI 4 is mounted on substrate 1 on which light-emitting devices 2a for three channels and photodetector 7a for one channel have been mounted. However, as can be seen from a comparison of FIGS. 24A and 24B, the heights of light-emitting devices 2a and photodetector 7a are uniformly aligned in optical-element integrated LSI 44 of the present invention in which a plurality of light-emitting devices 2a and photodetector 7a have been mounted as a group on substrate 1. In contrast, discrepancies occur in the heights of each of the optical elements in the optical-element integrated LSI of FIG. 24B in which light-emitting devices 2a and photodetector 7a have been mounted one at a time for each channel on substrate 1.

On optoelectrical hybrid substrate 26, optical waveguides 24 and optical waveguide end-surface mirrors 25 are formed on the surface, and further, electrical wiring (not shown) is also formed. In addition, optical-element integrated LSI 44 and optoelectrical hybrid substrate 26 are electrically connected using solder bumps 3, and optical coupling is realized by aligning the positions of optical waveguide end-surface mirrors 25 and the light-emitting and light-receiving optical components of optical-element integrated LSI 44 in the X, Y, and Z-directions. In this case, the X direction indicates the direction parallel to the surface of optoelectrical hybrid substrate 26, the Y direction indicates the direction perpendicular to the plane of the figure, and the Z direction indicates the direction perpendicular to the surface of optoelectrical hybrid substrate 26; and FIGS. 24A and 24B show profiles in the X and Z directions. The relatively low-speed signals, power supply, and ground of optical-element integrated LSI 44 are electrically exchanged with optoelectrical hybrid substrate 26 by way of solder bumps 3; and high-speed signals are exchanged using light-emitting devices 2a, photodetectors 7a, and optical waveguides 24.

In this case, to realize optical coupling of optical signals that are supplied as output from optical-element integrated LSI 44 at high efficiency, and moreover, at the same efficiency for all channels, the relative positions of optical waveguide end-surface mirrors 25 and each of light-emitting devices 2a and photodetectors 7a must be aligned for each channel.

Here, if optical-element integrated LSI 44 of FIG. 24A, in which the heights of the plurality of light-emitting devices 2a and photodetectors 7a are uniform with respect to substrate 1, is mounted parallel, and moreover, in close proximity to optoelectrical hybrid substrate 26 with light-emitting devices 2a and photodetectors 7a aligned with the optical axis of optical waveguide end-surface mirrors 25, the distance (in the Z direction) between optical waveguide end-surface mirrors 25 and each of light-emitting devices 2a and photodetectors 7a will be uniform, and accordingly, highly efficient optical coupling can be realized that is identical for all channels. In addition, the plurality of optical signals that are supplied as output from optical-element integrated LSI 44 can be transmitted to optical waveguides 24 equally and at high strength, and the optical signals can be transmitted long distances on all channels. Regarding the reception of optical signals, the ability to realize equal and highly efficient coupling with optical waveguides 24 obtains the effect of enabling reception of weak optical signals from remote origins. In contrast, when the heights of the plurality of light-emitting devices 2a and photodetectors 7a are not uniform with respect to substrate 1, as in the optical-element integrated LSI of FIG. 24B, the distance (in the Z direction) between optical waveguide end-surface mirrors 25 and each of light-emitting devices 2a and photodetectors 7a will not be uniform even when the optical-element integrated LSI is mounted parallel to optoelectrical hybrid substrate 26, and discrepancies will occur in the optical coupling between the two devices. The problem will therefore arise that discrepancies will occur in the distances over which optical signals can be transmitted, the transmission distance will be reduced for channels in which the optical coupling efficiency is poor. In the case of the reception of optical signals as well, the problem will occur that the optical transmission distance will be reduced on channels in which coupling efficiency is poor.

What is claimed is:

1. An optical input substrate, which is a substrate on which a semiconductor integrated circuit can be mounted, comprising:
two or more photodetectors capable of converting optical signals that are received as input to electrical signals and supplying these electrical signals to a mounted semiconductor integrated circuit;
wherein the heights of said two or more photodetectors are identical.

2. An optical input substrate, which is a substrate on which a semiconductor integrated circuit can be mounted, comprising:
two or more photodetectors capable of converting optical signals that are received as input to electrical signals and supplying these electrical signals to a mounted semiconductor integrated circuit;
wherein the heights of said two or more photodetectors are identical, and moreover, wherein at least one of these two or more photodetectors is provided with an optics element having the function of focusing light that is received as input toward the photoreception surface of the photodetectors.

3. An optical input substrate according to claim 1, wherein all or a portion of said two or more photodetectors have a common electrode pattern.

4. An optical input substrate according to claim 2, wherein all or a portion of said two or more photodetectors have a common electrode pattern.

5. An optical output substrate, which is a substrate on which a semiconductor integrated circuit can be mounted, comprising:
two or more light-emitting devices capable of converting electrical signal that are supplied as output from a mounted semiconductor integrated circuit to optical signals and supplying these optical signals as output;
wherein the heights of said two or more light-emitting devices are identical.

6. An optical output substrate, which is a substrate on which a semiconductor integrated circuit can be mounted; comprising:
two or more light-emitting devices capable of converting electrical signals supplied as output from a mounted semiconductor integrated circuit to optical signals and supplying these optical signals as output;
wherein the heights of said two or more light-emitting devices are identical, and moreover, wherein at least one of said two or more light-emitting devices is provided with an optics element having the function of focusing light supplied as output from the light-emitting surface of the light-emitting devices.

7. An optical output substrate according to claim 5, wherein all or a portion of said two or more light-emitting devices have a common electrode pattern.

8. An optical output substrate according to claim 6, wherein all or a portion of said two or more light-emitting devices have a common electrode pattern.

9. An optical input/output substrate, which is a substrate on which a semiconductor integrated circuit can be mounted; comprising:
two or more photodetectors capable of converting optical signals that are received as input to electrical signals and supplying these electrical signals to a mounted semiconductor integrated circuit; and
two or more light-emitting devices capable of converting electrical signals that supplied as output from a mounted semiconductor integrated circuit to optical signals and supplying these optical signals as output;
wherein the heights of said two or more photodetectors are identical, and moreover, the heights of said two or more light-emitting devices are identical.

10. An optical input/output substrate according to claim 9, wherein the heights of said two or more photodetectors and the heights of said two or more light-emitting devices are identical.

11. An optical input/output substrate according to claim 9, wherein one or both of said photodetectors and light-emitting devices are provided with optics elements having the function of focusing incident light.

12. An optical input/output substrate according to claim 10, wherein one or both of said photodetectors and light-emitting devices are provided with optics elements having the function of focusing incident light.

13. An optical input/output substrate according to claim 9, wherein all or a portion of said two or more photodetectors and light-emitting devices have a common electrode pattern.

14. An optical input/output substrate according to claim 10, wherein all or a portion of said two or more photodetectors and light-emitting devices have a common electrode pattern.

15. An optical input/output substrate according to claim 11, wherein all or a portion of said two or more photodetectors and light-emitting devices have a common electrode pattern.

16. An optical input/output substrate according to claim 12, wherein all or a portion of said two or more photodetectors and light-emitting devices have a common electrode pattern.

17. An optical input/output substrate according to claim 9, wherein the melting point of solder for securing said photodetectors to said substrate is different from the melting point of solder for securing said light-emitting devices to said substrate.

18. An optical-element integrated semiconductor integrated circuit, wherein a semiconductor integrated circuit is mounted on an optical input substrate according to claim 1, and electrical signals that have been converted by photodetectors belonging to said optical input substrate are supplied as output to the electrical signal input ports of this semiconductor integrated circuit.

19. An optical-element integrated semiconductor integrated circuit, wherein a semiconductor integrated circuit is mounted on an optical output substrate according to claim 5, and electrical signals supplied as output from the electrical signal output ports of this semiconductor integrated circuit are converted to optical signals by light-emitting devices belonging to said optical output substrate and supplied as output.

20. An optical-element integrated semiconductor integrated circuit, wherein a semiconductor integrated circuit is mounted on an optical input/output substrate according to claim 9, and electrical signals that have been converted by photodetectors belonging to said optical input/output substrate are supplied as output to electrical signal input ports of this semiconductor integrated circuit, and electrical signals that are supplied as output from electrical signal output ports of said semiconductor integrated circuit are converted to optical signals by light-emitting devices belonging to said optical input/output substrate and supplied as output.

21. A fabrication method of an optical input substrate on which are mounted two or more photodetectors for converting received optical signals to electrical signals, said fabrication method comprising photodetector mounting steps that include steps of:
forming bumps on only necessary photodetectors of a photodetector array;
using said bumps to mount said photodetector array on a substrate to thus connect photodetectors on which said bumps have been formed to input ports of said substrate;
covering said photodetectors that have been connected to said input ports with a protective film;
removing unnecessary photodetectors that are not covered with said protective film from said photodetector array; and
removing said protective film.

22. A fabrication method of an optical output substrate on which are mounted two or more light-emitting devices for converting received electrical signals to optical signals, said fabrication method comprising light-emitting device mounting steps that include steps of:
covering only necessary light-emitting devices among a light-emitting device array with a protective film;
removing the functional portions of unnecessary light-emitting devices that are not covered by said protective film;
removing said protective film; and
mounting said light-emitting device array in which the functional portions of said unnecessary light-emitting devices have been removed on a substrate, and connecting said necessary light-emitting devices to output ports of said substrate.

23. A fabrication method of an optical output substrate on which are mounted two more light-emitting devices for converting received electrical signals to optical signals, said fabrication method comprising light-emitting device mounting steps that include steps of:
covering only necessary light-emitting devices in a light-emitting device array with a protective film;
removing unnecessary light-emitting devices that are not covered by said protective film together with the element substrate;
removing said protective film; and
mounting said light-emitting device array in which said unnecessary light-emitting devices have been removed on a substrate and connecting said necessary light-emitting devices to output ports of said substrate.

24. A fabrication method of an optical input/output substrate on which are mounted both photodetectors and light-emitting devices, said fabrication method comprising:
photodetector mounting steps that include steps of:
forming bumps on only necessary photodetectors in a photodetector array;
using said bumps to mount said photodetector array on a substrate and thus to connect photodetectors on which said bumps have been formed to input ports of said substrate;
covering said photodetectors that have been connected to said input ports with a protective film;
removing unnecessary photodetectors that are not covered by said protective film from said photodetector array; and
removing said protective film; and
light-emitting device mounting steps that include steps of:
covering only necessary light-emitting devices in a light-emitting device array with a protective film;
removing the functional portions of unnecessary light-emitting devices that are not covered by said protective film;
removing said protective film; and
mounting on a substrate said light-emitting device array in which the functional portions of said unnecessary light-emitting devices have been removed, and connecting said necessary light-emitting devices to output ports of said substrate.

25. A fabrication method of an optical input/output substrate on which both photodetectors and light-emitting devices are mounted, said fabrication method comprising:
photodetector mounting steps that include steps of:
forming bumps on only necessary photodetectors in a photodetector array;
using said bumps to mount said photodetector array on a substrate to thus connect photodetectors on which said bumps have been formed to input ports of said substrate;
covering said photodetectors that have been connected to said input ports with a protective film;
removing unnecessary photodetectors that have not been covered by said protective film from said photodetector array; and
removing said protective film; and
light-emitting device mounting steps that include steps of:
covering only necessary light-emitting devices in a light-emitting device array with a protective film;
removing unnecessary light-emitting devices that have not been covered by said protective film together with the element substrate;
removing said protective film; and
mounting said light-emitting device array from which said unnecessary light-emitting devices have been removed, and connecting said necessary light-emitting devices to output ports of said substrate.

26. A fabrication method of an optical input substrate according to claim 21, further including a step of etching the element substrate of said photodetector array to form a thin-film.

27. A fabrication method of an optical output substrate according to claim 22, further including a step of etching the element substrate of said light-emitting device array to form a thin-film.

28. A fabrication method of an optical output substrate according to claim 23, further including a step of etching the element substrate of said light-emitting device array to form a thin-film.

29. A fabrication method of an optical input/output substrate according to claim 24, further including a step of etching one or both of the element substrate of said photodetector array and the element substrate of said light-emitting device array to form a thin-film.

30. A fabrication method of an optical input/output substrate according to claim 25, further including a step of etching one or both of the element substrate of said photodetector array and the element substrate of said light-emitting device array to form a thin-film.

31. A fabrication method of an optical input substrate according to claim 21, further including a step of etching the element substrate of said photodetector array to form a lens.

32. A fabrication method of an optical output substrate according to claim 22, further including a step of etching the element substrate of said light-emitting device array to form a lens.

33. A fabrication method of an optical input/output substrate according to claim 24, further including a step of etching one or both of the element substrate of said photodetector array and the element substrate of said light-emitting device array to form lenses.

34. A fabrication method of an optical input/output substrate according to claim 25, further including a step of etching one or both of the element substrate of said photodetector array and the element substrate of said light-emitting device array to form lenses.
